(19) United States
(12) Patent Application Publication
(10) Pub. No.: US 2024/0132664 A1
(43) Pub. Date: Apr. 25, 2024

(54) FLUOROPOLYETHER COMPOUND, LUBRICANT, MAGNETIC DISK, AND METHOD FOR PRODUCING FLUOROPOLYETHER COMPOUND

(71) Applicant: Moresco Corporation, Kobe-shi (JP)

(72) Inventors: Akinori KIMURA, Kobe-shi (JP); Ryosuke SAGATA, Kobe-shi (JP)

(21) Appl. No.: 18/373,439

(22) Filed: Sep. 27, 2023

(30) Foreign Application Priority Data
Sep. 30, 2022 (JP) 2022-158913

(51) Int. Cl. C08G 65/331; C08G 65/00; C10M 107/38; G11B 5/725

(52) U.S. Cl. CPC C08G 65/3312; C08G 65/007; C10M 107/38; G11B 5/7257; C08G 2650/04; C08G 2650/48; C10M 2213/0606; C10N 2030/06

(57) ABSTRACT

An object to provide a lubricant that makes it possible, in a magnetic disk device in which energy assisted recording technology such as HAMR is employed, to prevent or reduce oxidative decomposition in an oxygen-containing atmosphere and maintain high heat resistance in the oxygen-containing atmosphere is attained by a fluoropolyether compound containing at least one ether bond in a molecule, wherein at least one hydrogen atom bonded to a carbon atom bonded to an oxygen atom of the ether bond in the molecule is substituted with fluorine.

This Nonprovisional application claims priority under 35 U.S.C. § 119 on Patent Application No. 2022-158913 filed in Japan on Sep. 30, 2022, the entire contents of which are hereby incorporated by reference.

### TECHNICAL FIELD

The present invention relates to a fluoropolyether compound, a lubricant, a magnetic disk, and a method for producing a fluoropolyether compound.

### BACKGROUND ART

In order to allow magnetic disk devices such as a hard disk drive (HDD) to have a larger storage capacity, magnetic disk devices are being developed in which energy assisted recording technology such as heat-assisted magnetic recording (HAMR) technology is employed.

According to magnetic disk devices in which energy assisted recording technology is employed, magnetism of a magnetic disk is controlled by applying energy to a magnetic layer during recording of data with use of a laser beam, a microwave, or the like. This results in heating of the magnetic layer by the energy.

A magnetic disk surface lubricant is applied to an outermost surface of a magnetic disk for the purpose of surface protection. In a magnetic disk device in which energy assisted recording technology is employed, a magnetic disk surface lubricant is also exposed to high temperature. This causes a demand for a highly heat-resistant lubricant that makes it possible to maintain a surface protection layer even under high temperature.

Known examples of a magnetic disk lubricant that is used for a magnetic disk device in which energy assisted recording technology such as HAMR is employed include lubricants (see, for example, Patent Literatures 1 to 3) wherein an ether group-containing hydrocarbon group having a hydroxy group is introduced to a terminal of a perfluoropolyether group. These lubricants have high affinity with a disk and high heat resistance.

### CITATION LIST

### Patent Literature

[Patent Literature 1]
International Publication No. WO2009/066784
[Patent Literature 2]
International Publication No. WO2021/002178
[Patent Literature 3]
International Publication No. WO2016/084781

### SUMMARY OF INVENTION

### Technical Problem

In energy assisted recording technology such as HAMR, a magnetic disk is exposed to high temperature. However, a conventional lubricant has room for improvement in terms of heat resistance that can withstand heating by HAMR.

Writing to a magnetic disk is ordinarily carried out in an inert gas such as helium. The inventors of the present invention uniquely found the following. Specifically, the inert gas can also contain a very small amount of oxygen. Occurrence of oxidative decomposition of a lubricant in such a case causes the lubricant to, for example, disappear and change in structure. This leads to a lower lubrication action. Thus, the inventors of the present invention set an object to provide a lubricant that makes it possible, in a magnetic disk device in which energy assisted recording technology such as HAMR is employed, to prevent or reduce decomposition even during heating of a disk.

That is, an aspect of the present invention has an object to provide (i) a fluoropolyether compound that makes it possible to prevent or reduce decomposition in an oxygen-containing atmosphere and maintain high heat resistance in the oxygen-containing atmosphere, (ii) a lubricant, (iii) a magnetic disk containing the lubricant, and (iv) a method for producing a fluoropolyether compound.

### Solution to Problem

In order to attain the object, a fluoropolyether compound in accordance with an embodiment of the present invention includes the following aspects.

A fluoropolyether compound represented by the following Formula (1):

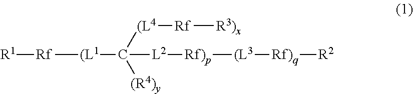

where: Rf are each independently a perfluoropolyether group;

R¹ is a hydrocarbon group having two or more OH groups, or a hydrocarbon group having at least one cyclic hydrocarbon group;

R² and R³ are each independently a hydrocarbon group having at least one OH group, or a hydrocarbon group having at least one cyclic hydrocarbon group;

L¹, L², L³, and L⁴ are each independently a hydrocarbon group, and the hydrocarbon group may contain an OH group and/or an ether bond;

R⁴ is a hydrogen atom or a hydrocarbon group, and the hydrocarbon group may contain an OH group and/or an ether bond;

p is an integer of 0 to 1, q is a real number of 0 to 10, and when p=1, (i) x=1 and y=1 or (ii) x=2 and y=0;

in a molecule, a hydrogen atom bonded to a carbon atom contained in a hydrocarbon group may be substituted with a fluorine atom; and

at least any one of R¹, R², and R³ may contain an ether bond obtained by substituting at least one carbon atom with an oxygen atom, and at least one hydrogen atom bonded to a carbon atom adjacent to the oxygen atom of the ether bond is substituted with a fluorine atom.

A method for producing a fluoropolyether compound in accordance with an embodiment of the present invention includes the following aspects.

A method for producing a fluoropolyether compound, including:

an esterification step of introducing ester into a compound;

a fluorination step of fluorinating the ester obtained in the esterification step; and a reduction step of reducing the fluorinated ester obtained in the fluorination step, the compound being represented by the following Formula (2):

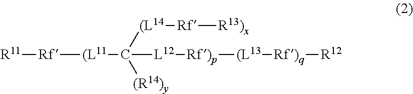

where: Rf′ are each independently a perfluoropolyether group;

R¹¹, R¹², and R¹³ are each independently a hydrocarbon group having at least one OH group;

L¹¹, L¹², L¹³, and L¹⁴ are each independently a hydrocarbon group, and the hydrocarbon group may contain an OH group and/or an ether bond;

R¹⁴ is a hydrocarbon group or a hydrogen atom, and the hydrocarbon group may have an OH group and/or contain an ether bond;

at least any one of R¹¹, R¹², and R¹³ contains an ether bond obtained by substituting at least one carbon atom with an oxygen atom; and

p is an integer of 0 to 1, q is a real number of 0 to 10, and when p=1, (i) x=1 and y=1 or (ii) x=2 and y=0.

### Advantageous Effects of Invention

That is, according to an aspect of the present invention, it is possible to provide (i) a fluoropolyether compound that makes it possible to prevent or reduce decomposition in an oxygen-containing atmosphere and maintain high heat resistance in the oxygen-containing atmosphere, (ii) a lubricant, and (iii) a magnetic disk that is provided with a lubricant layer containing the lubricant.

### BRIEF DESCRIPTION OF DRAWINGS

FIG. 1 is a cross-sectional view illustrating a configuration of a magnetic disk in accordance with an embodiment of the present invention.

FIG. 2 is a cross-sectional view illustrating a configuration of a magnetic disk in accordance with an embodiment of the present invention.

### DESCRIPTION OF EMBODIMENTS

The following description will discuss embodiments of the present invention in detail. Note, however, that the present invention is not limited to the embodiments, but can be altered within this disclosure. The present invention also encompasses, in its technical scope, any embodiment derived by combining technical means disclosed in differing embodiments. Note that the expression “A to B”, which represents a numerical range, is intended to mean “not less than A but not more than B” unless otherwise specified herein.

[1. Fluoropolyether Compound]

While carrying out diligent study in view of the above object, the inventors of the present invention considered that a lubricant, like those disclosed in Patent Literatures 1 to 3, wherein an ether group-containing hydrocarbon group having a hydroxy group is introduced to a terminal of a perfluoropolyether group, seems to easily cause oxidative decomposition of an ether site in an oxygen-containing high-temperature atmosphere. Thus, the inventors of the present invention synthesized a fluoropolyether compound obtained by substituting, with fluorine, a hydrogen atom bonded to a carbon atom bonded to an oxygen atom of an ether bond in a molecule, and evaluated oxidative stability of the fluoropolyether compound. As a result, the inventors of the present invention found that decomposition is less likely to occur even in an oxygen-containing high-temperature atmosphere, and finally accomplished the present invention. Furthermore, it was also found that in a magnetic disk on which a lubricant layer is formed by using such a fluoropolyether compound as a lubricant, the lubricant layer remains at a high ratio even after heat treatment is carried out in an oxygen-containing high-temperature atmosphere. Moreover, it was also shown that in a magnetic disk on which a lubricant layer is formed by using such a fluoropolyether compound as a lubricant, the lubricant layer remains at a high ratio even after ultraviolet irradiation.

That is, a fluoropolyether compound in accordance with an embodiment of the present invention is a fluoropolyether compound represented by the following Formula (1):

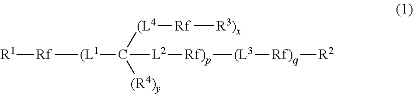

(Rf in Formula (1))

In Formula (1), Rf are each independently a perfluoropolyether group. The perfluoropolyether group is exemplified by, but not particularly limited to, a perfluoropolyether group represented by the following Formula (4):

—(CF₂)_{g}—O—(CF₂O)_{b}(CF₂CF₂O)_{c}(CF₂CF₂CF₂O)_{d}(CF₂CF₂CF₂CF₂O)ₑ(CF₂CF(CF₃)O)_{f}—(CF₂)ₕ— (4)

where b, c, d, e, and f are each independently a real number of 0 to 30, and more preferably a real number of 0 to 25, in each Rf. Note, however, that at least any one of b, c, d, e, and f is a real number of not less than 1. g and h are each independently an integer of 0 to 3 in each Rf. Note here that b, c, d, e, and f mean average degrees of polymerization and are values calculated by ¹⁹F-NMR measurement with use of JNM-ECX400 available from JEOL Ltd. In the NMR measurement, a sample was used as it was without use of a solvent. A known peak that indicates a part of a skeleton structure of fluoropolyether was used as a reference for a chemical shift.

Examples of the Rf include perfluoropolyether groups each including at least one selected from the group consisting of: Demnum backbone (C3 backbone): —(CF₂CF₂CF₂O)_{d}—, Fomblin backbone (C1C2 backbone): —(CF₂O)_{b}(CF₂CF₂O)_{c}—, C2 backbone: —(CF₂CF₂O)_{c}—, C4 backbone: —(CF₂CF₂CF₂CF₂O)ₑ—, and Krytox backbone: —(CF₂CF(CF₃)O)_{f}—.

More preferable examples of the Rf include a group in which b, c, d, e, and f in Formula (4) satisfy any of the following (i) to (v). Such a group is preferable because the following configurations make a molecular chain flatter.
(i) b=a real number of 2 to 12, c=a real number of 2 to 12, and d, e, and f=0.
(ii) c=a real number of 4 to 14, and b, d, e, and f=0.
(iii) d=a real number of 2 to 12, and b, c, e, and f=0.
(iv) e=a real number of 1 to 9, and b, c, d, and f=0.
(v) f=a real number of 2 to 12, and b, c, d, and e=0.

Note that in the Fomblin backbone, CF₂O and CF₂CF₂O can be randomly repeated.

(R¹ in Formula (1))

In Formula (1), R¹ is a hydrocarbon group having two or more OH groups, or a hydrocarbon group having at least one cyclic hydrocarbon group. R¹ that has two or more OH groups or at least one cyclic hydrocarbon group results in higher adhesion between the fluoropolyether compound represented by Formula (1) and a magnetic disk and is therefore preferable.

The hydrocarbon group having two or more OH groups is not limited to but is a hydrocarbon group having two or more OH groups and having 2 to 10 carbon atoms, more preferably 2 to 5 carbon atoms, and even more preferably 2 to 3 carbon atoms. The hydrocarbon group may be linear or branched. Provided that the number of OH groups of the hydrocarbon group having two or more OH groups is not less than 2, the number is not limited to but is, for example, 2 to 8, more preferably 2 to 6, and even more preferably 2 to 4. From the viewpoint of adhesion to a magnetic disk, the hydrocarbon group preferably contains a primary OH group. The hydrocarbon group having two or more OH groups may contain an ether bond obtained by substituting a carbon atom of the hydrocarbon group with an oxygen atom. In a case where the hydrocarbon group contains the ether bond, the number of ether bonds is, for example, 1 to 10, more preferably 1 to 5, and even more preferably 1 to 3. More preferable examples of the hydrocarbon group having two or more OH groups include a group represented by the following Formula (5) or (6):

—(CH₂)r—O—(CH₂)s—CH(OH)—CH₂(OH) (5)

—(CH₂)t—O—(CH₂)u—CH((CH₂)v—OH)((CH₂)w—OH) (6)

In Formula (5), r is an integer of 0 to 3, s is an integer of 0 to 3. In Formula (6), t is an integer of 0 to 3, u is an integer of 0 to 4, v is an integer of 1 to 5, and w is an integer of 1 to 5. Preferable examples of the group represented by the Formula (5) or (6) include —CH₂OCH₂CH(OH)CH₂OH and —CH₂OCH₂CH₂CH(CH₂—OH)₂.

Other examples of the hydrocarbon group having two or more OH groups include —CH₂OCH₂CH(OH)CH₂OCH₂CH(OH)CH₂OH, —CH₂OCH₂CH(OH)CH₂OCH₂C(CH₂CH₃)(CH₂OH)₂, and —CH₂OCH₂CH(OH)CH₂OCH₂CH₂OH.

The hydrocarbon group having at least one cyclic hydrocarbon group is not limited to but is a hydrocarbon group having at least one cyclic hydrocarbon group and having 3 to 25 carbon atoms, more preferably 3 to 18 carbon atoms, and even more preferably 7 to 12 carbon atoms. The hydrocarbon group may contain an ether bond obtained by substituting a carbon atom of the hydrocarbon group with an oxygen atom. The hydrocarbon group may have a linear or branched part other than the cyclic hydrocarbon group provided that the hydrocarbon group has at least one cyclic hydrocarbon group.

Provided that the number of cyclic hydrocarbon groups of the hydrocarbon group having at least one cyclic hydrocarbon group is not less than 1, the number is not limited to but is, for example, 1 to 5, more preferably 1 to 3, and even more preferably 1 to 2. The cyclic hydrocarbon group is a cyclic hydrocarbon group having, for example, 3 to 10 carbon atoms, more preferably 3 to 8 carbon atoms, and even more preferably 5 to 6 carbon atoms. The cyclic hydrocarbon group may be monosubstituted, disubstituted, or more multisubstituted. The cyclic hydrocarbon group may be an alicyclic hydrocarbon group or an aromatic hydrocarbon group. Alternatively, the cyclic hydrocarbon group may be a monocyclic hydrocarbon group or a condensed polycyclic hydrocarbon group. Examples of the cyclic hydrocarbon group include a phenyl group, a phenylene group, a naphthyl group, a naphthylene group, a cyclohexyl group, a cyclohexylene group, a cyclopentyl group, and a cyclopentylene group.

The number of ether bonds contained in the hydrocarbon group having at least one cyclic hydrocarbon group is not limited to but is, for example, 0 to 10, more preferably 0 to 5, and even more preferably 0 to 3.

R¹ that is a hydrocarbon group having at least one cyclic hydrocarbon group more preferably has at least one OH group. That is, the above-described hydrocarbon group having at least one cyclic hydrocarbon group is more preferably a hydrocarbon group having at least one OH group and at least one cyclic hydrocarbon group. R¹ that has at least one OH group and at least one cyclic hydrocarbon group results in higher adhesion between the fluoropolyether compound represented by Formula (1) and a magnetic disk even in a case where the at least one cyclic hydrocarbon group is an alicyclic hydrocarbon group, and is therefore preferable.

Provided that the number of OH groups of the hydrocarbon group having at least one OH group and at least one cyclic hydrocarbon group is not less than 1, the number is not limited to but is, for example, 1 to 10, more preferably 1 to 5, and even more preferably 1 to 3.

Examples of the hydrocarbon group having at least one cyclic hydrocarbon group include a group represented by the following Formula (7):

—(CH₂)i—O—(CH₂)j—CH(OH)—(CH₂)k—O-A-R⁵ (7)

where: i is an integer of 1 to 3; j is an integer of 1 to 3; k is an integer of 1 to 3; m is an integer of 1 to 10; A is the cyclic hydrocarbon group; and R⁵ is, for example, —H, —OH, —NO₂, a perfluoroalkyl group having 1 to 10 carbon atoms (e.g., —CF₃), or an alkoxy group having 1 to 10 carbon atoms (e.g., a methoxy group, an ethoxy group, or a propoxy group).

Preferable examples of the group represented by the Formula (7) include —CH₂OCH₂CH(OH)CH₂OC₆H₅, —CH₂OCH₂CH(OH)CH₂OC₁₀H₇, —CH₂OCH₂CH(OH)CH₂O(C₆H₄)NO₂, —CH₂OCH₂CH(OH)CH₂O(C₆H₅)OH, and —CH₂OCH₂CH(OH)CH₂O(C₆H₁₀)OCH₃.

(R² and R³ in Formula (1))

In Formula (1), R² and R³ are each independently a hydrocarbon group having at least one OH group, or a hydrocarbon group having at least one cyclic hydrocarbon group. R² and R³ each of which has at least one OH group or at least one cyclic hydrocarbon group results in higher adhesion between the fluoropolyether compound represented by Formula (1) and a magnetic disk and is therefore preferable.

The hydrocarbon group having at least one OH group is not limited to but is a hydrocarbon group having at least one OH group and having 1 to 10 carbon atoms, more preferably 1 to 5 carbon atoms, and even more preferably 1 to 3 carbon atoms. The hydrocarbon group may be linear or branched. Provided that the number of OH groups of the hydrocarbon group having at least one OH group is not less than 1, the number is not limited to but is, for example, 1 to 8, more preferably 2 to 6, and even more preferably 2 to 4. From the viewpoint of adhesion to a magnetic disk, the hydrocarbon group preferably contains a primary OH group. The hydrocarbon group may contain an ether bond obtained by substituting a carbon atom of the hydrocarbon group with an oxygen atom. The number of ether bonds contained in the hydrocarbon group having at least one OH group is not limited to but is, for example, 0 to 10, more preferably 0 to 5, and even more preferably 0 to 3. In a case where the hydrocarbon group having at least one OH group has one OH group, more preferable examples of such a case include a group represented by the following Formula (8):

—(CH₂)n—OH (8)

where n is an integer of 0 to 3. A more preferable example of a case where the hydrocarbon group having at least one OH group has two or more OH groups is identical to the hydrocarbon group having two or more OH groups, the hydrocarbon group having been mentioned to describe R¹.

The hydrocarbon group having at least one cyclic hydrocarbon group is identical to the group mentioned to describe R¹.

(L¹, L², L³, and L⁴ in Formula (1))

In Formula (1), L¹, L², L³, and L⁴ are each independently a hydrocarbon group that may contain an OH group and/or an ether bond. L¹, L², L³, and L⁴ each preferably independently have at least one OH group. L¹, L², L³, and L⁴ each of which has at least one OH group results in higher adhesion between the fluoropolyether compound represented by Formula (1) and a magnetic disk and is therefore preferable. A hydrocarbon group that may contain an ether bond is a hydrocarbon group that contains an ether bond obtained by substituting a carbon atom of the hydrocarbon group with an oxygen atom.

The hydrocarbon group is not limited to but is a hydrocarbon group having 1 to 25 carbon atoms, more preferably 2 to 18 carbon atoms, and even more preferably 2 to 12 carbon atoms. A carbon atom of the hydrocarbon group may be substituted with an oxygen atom to form an ether bond. The hydrocarbon group may be linear or branched. In a case where the hydrocarbon group has at least one OH group, the number of OH groups is, for example, 1 to 8, more preferably 1 to 5, and even more preferably 1 to 3. In a case where the hydrocarbon group contains an ether bond, the number of ether bonds is, for example, 1 to 10, more preferably 1 to 5, and even more preferably 1 to 3.

(R⁴ in Formula (1))

In Formula (1), R⁴ is a hydrocarbon group or a hydrogen atom. The hydrocarbon group is preferably a hydrocarbon group having 1 to 15 carbon atoms, more preferably 1 to 10 carbon atoms, and even more preferably 1 to 5 carbon atoms. The hydrocarbon group may contain an ether bond obtained by substituting a carbon atom of the hydrocarbon group with an oxygen atom. The hydrocarbon group may be linear or branched. The hydrocarbon group may have an OH group, and the number of OH groups is, for example, 0 to 8, more preferably 0 to 5, and even more preferably 0 to 2. The number of ether bonds contained in the hydrocarbon group is, for example, 0 to 8, more preferably 0 to 5, and even more preferably 0 to 3.

(p, q, x, and y in Formula (1))

In Formula (1), p is an integer of 0 to 1, q is a real number of 0 to 10, and when p=1, (i) x=1 and y=1 or (ii) x=2 and y=0. q is a mean value calculated according to the above-described method by ¹H-NMR measurement with use of JNM-ECX400 available from JEOL Ltd., and is a real number.

(Fluorine Substitution)

The fluoropolyether compound represented by the Formula (1) may be configured such that at least any one of R¹, R², and R³ contains an ether bond obtained by substituting at least one carbon atom with an oxygen atom. In such a case, at least one hydrogen atom bonded to a carbon atom adjacent to the oxygen atom of the ether bond of R¹, R², and R³ is substituted with a fluorine atom. Note here that the wording “a carbon atom adjacent to an oxygen atom of an ether bond” is intended to mean a carbon atom bonded to an oxygen atom of an ether bond. It has been found that in a case where the fluoropolyether compound which has such a configuration is used as a lubricant, the lubricant is less likely to be decomposed even in an oxygen-containing high-temperature atmosphere. The reason for this seems to be the following: Since at least one hydrogen atom bonded to a carbon atom adjacent to an oxygen atom of an ether bond in a molecule is substituted with a fluorine atom, oxidative decomposition of an ether site in an oxygen-containing high-temperature atmosphere is less likely to occur.

The fluoropolyether compound represented by the Formula (1) only needs to be configured such that at least one hydrogen atom bonded to a carbon atom adjacent to an oxygen atom of the ether bond of R¹, R², and R³ is substituted with a fluorine atom. Note, however, that at least one hydrogen atom bonded to a carbon atom adjacent to an ether bond present in a hydrocarbon group having two or more OH groups or in a hydrocarbon group having a cyclic hydrocarbon group is preferably substituted with a fluorine atom. The fluoropolyether compound that has this configuration is preferable because in an oxygen-containing high-temperature atmosphere, decomposition of the lubricant is less likely to occur, and a state in which the lubricant is strongly bonded to a magnetic disk is maintained. Furthermore, since there is no part in which oxidative decomposition of the ether site is more likely to occur, all hydrogen atoms bonded to a carbon atom adjacent to an oxygen atom of at least one ether bond of R¹, R², and R³ are preferably substituted with fluorine atoms. All hydrogen atoms bonded to a carbon atom adjacent to oxygen atoms of all ether bonds of R¹, R², and R³ are even more preferably substituted with fluorine atoms. In a case where the fluoropolyether compound that has such a structure is used as the lubricant, the lubricant is less likely to be decomposed even in an oxygen-containing high-temperature atmosphere.

The fluoropolyether compound represented by the Formula (1) only needs to be configured such that at least one hydrogen atom bonded to a carbon atom adjacent to an oxygen atom of the ether bond of R¹, R², and R³ is substituted with a fluorine atom. Note, however, that another hydrogen atom in a molecule may be substituted with a fluorine atom.

In particular, the fluoropolyether compound represented by the Formula (1) is more preferably configured such that in a case where at least any one of R⁴, L¹, L², L³, and L⁴ contains an ether bond, at least one hydrogen atom bonded to a carbon atom adjacent to an oxygen atom of the ether bond is substituted with a fluorine atom. All hydrogen atoms bonded to a carbon atom adjacent to an oxygen atom of the ether bond are even more preferably substituted with fluorine atoms. The perfluoropolyether compound that has this configuration is less susceptible to oxidative decomposition in an atmosphere where oxygen is present.

The fluoropolyether compound represented by the Formula (1) is even more preferably configured such that all hydrogen atoms bonded to a carbon atom other than a carbon atom bonded to OH groups of R¹, R², R³, R⁴, L¹, L², L³, and L⁴ are substituted with fluorine atoms. This is because the perfluoropolyether compound thus configured is less susceptible to oxidative decomposition in an atmosphere where oxygen is present.

(Fluoropolyether Compound in Accordance with an Embodiment of the Present Invention)

The fluoropolyether compound in accordance with an embodiment of the present invention is not particularly limited provided that the fluoropolyether compound is represented by the Formula (1), and can be, for example, a fluoropolyether compound represented by the following Formula (1-1), (1-2), (1-3), or (1-4). In the following Formulas (1-1) to (1-4), Rf, R¹, R², R³, R⁴, L¹, L², L³, and L⁴, and fluorine substitution are as have been described earlier.

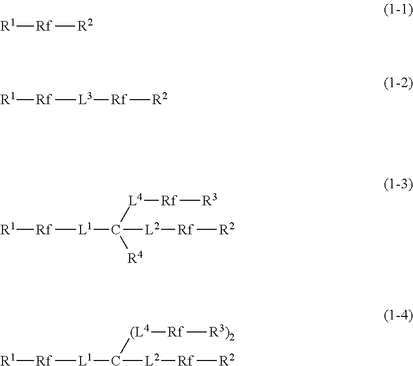

More specific examples of the fluoropolyether compound in accordance with an embodiment of the present invention include compounds 1 to 6 represented by the following formulas:

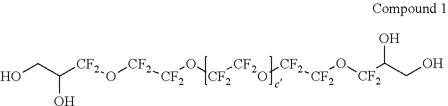

The compound 1 is a fluoropolyether compound (corresponding to the Formula (1-1)) that has p=0 and q=0 in the Formula (1). Note that the number c′ of repeating units of perfluoropolyether in the compound 1 is the number of repeating units of perfluoropolyether used to synthesize the compound 1 (this also applies to the following compounds 2 to 5). In the compound 1, Rf in Formula (1) is one of perfluoropolyether groups represented by Formula (4), the one being a perfluoropolyether group of the foregoing (ii). c in the perfluoropolyether group of the (ii) is greater in number than c′ by 2 due to substitution with a fluorine atom.

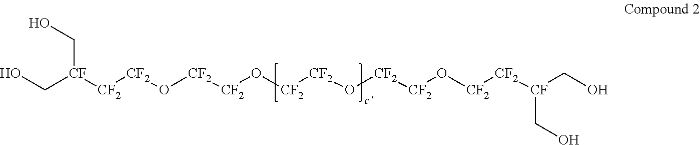

The compound 2 is a fluoropolyether compound (corresponding to the Formula (1-1)) that has p=0 and q=0 in the Formula (1).

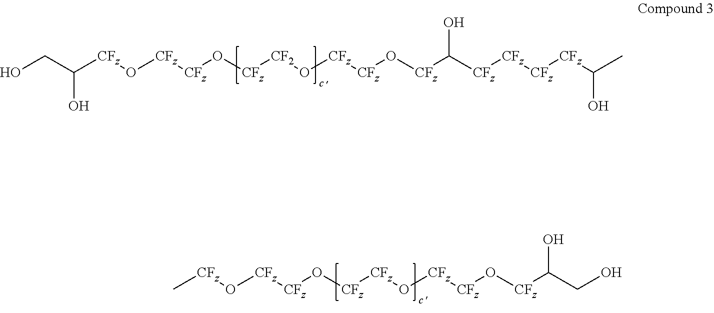

The compound 3 is a fluoropolyether compound (corresponding to the Formula (1-2)) that has p=0 and q=1 in the Formula (1).

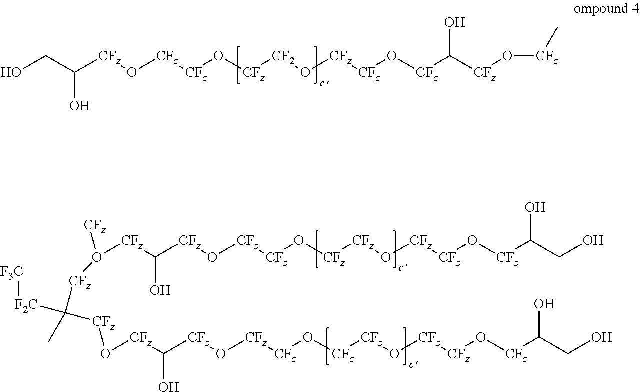

The compound 4 is a fluoropolyether compound (corresponding to the Formula (1-3)) that has p=1, q=0, x=1, and y=1 in the Formula (1).

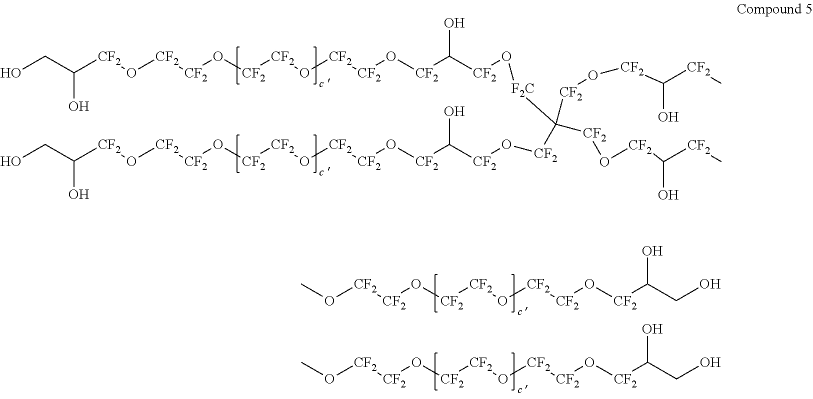

The compound 5 is a fluoropolyether compound (corresponding to the Formula (1-4)) that has p=1, q=0, x=2, and y=0 in the Formula (1).

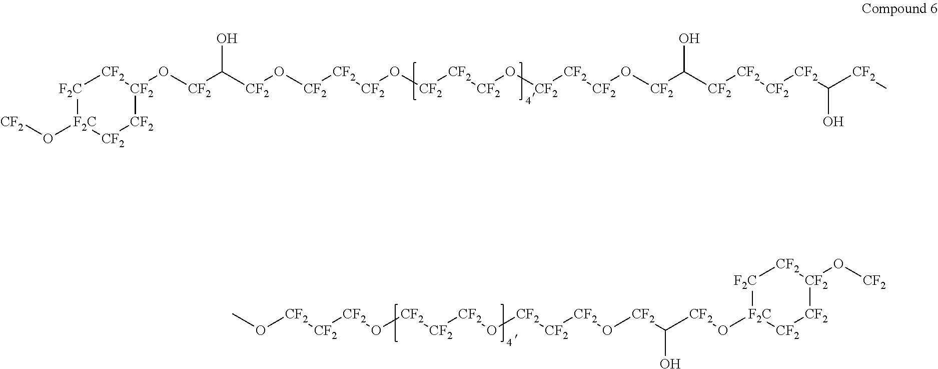

The compound 6 is a fluoropolyether compound (corresponding to the Formula (1-2)) that has p=0 and q=1 in the Formula (1). Note that the number d′ of repeating units of perfluoropolyether in the compound 6 is the number of repeating units of perfluoropolyether used to synthesize the compound 6.

The fluoropolyether compound in accordance with an embodiment of the present invention is preferably a liquid or solid under normal conditions, and preferably has a number average molecular weight of 600 to 10,000. From the viewpoint of the evaporativity of a lubricant, the number average molecular weight is more preferably not less than 1,000. The fluoropolyether compound in accordance with an embodiment of the present invention is suitably used as a lubricant. Note that the number average molecular weight is a value calculated by ¹H and ¹⁹F-NMR measurement with use of JNM-ECX400 available from JEOL Ltd (described earlier).

[2. Method for Producing Fluoropolyether Compound]

A method for producing the fluoropolyether compound in accordance with an embodiment of the present invention is not particularly limited provided that the method makes it possible to produce the fluoropolyether compound in accordance with an embodiment of the present invention. The fluoropolyether compound in accordance with an embodiment of the present invention can be produced by fluorinating an esterified perfluoropolyether derivative or an esterified polyalkylene glycol derivative.

[2.1 Method for Fluorinating Esterified Perfluoropolyether Derivative]

The following description will discuss a method for producing a fluoropolyether compound that fluorinates an esterified perfluoropolyether derivative. A method for producing a fluoropolyether compound in accordance with the present embodiment includes, for example, an esterification step of introducing ester into a compound represented by the following Formula (2) (hereinafter may be referred to as a “perfluoropolyether derivative”); a fluorination step of fluorinating the ester obtained in the esterification step (hereinafter may be referred to as “perfluoropolyether derivative ester”); and a reduction step of reducing the fluorinated ester obtained in the fluorination step (hereinafter may be referred to as “fluorinated perfluoropolyether derivative ester”).

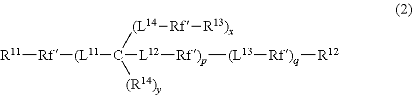

where: Rf′ are each independently a perfluoropolyether group; R¹¹, R¹², and R¹³ are each independently a hydrocarbon group having at least one OH group or at least one cyclic hydrocarbon group; L¹¹, L¹², L¹³, and L¹⁴ are each independently a hydrocarbon group; R¹⁴ is a hydrocarbon group or a hydrogen atom; p is an integer of 0 to 1; q is a real number of 0 to 10; and when p=1, (i) x=1 and y=1 or (ii) x=2 and y=0.

At least any one of R¹¹, R¹², and R¹³ contains an ether bond obtained by substituting at least one carbon atom with an oxygen atom. L¹¹, L¹², L¹³, and L¹⁴ each may independently have an OH group and/or contain an ether bond. In a case where R¹⁴ is a hydrocarbon group, the hydrocarbon group may have at least one OH group and/or contain an ether bond.

As a method for producing a fluoropolyether compound by fluorination, a method for fluorinating a hydrocarbon compound such as polyalkylene glycol was ordinarily used. However, in a case where a fluoropolyether compound having a large molecular weight was to be produced, the compound having a large molecular weight was difficult to fluorinate (see Japanese Patent Application Publication, Tokukai, No. 2018-90492). The inventors of the present invention have found a production method for fluorinating a fluoropolyether compound having a large molecular weight.

In Formula (2), Rf′ are each independently a perfluoropolyether group; Examples of the perfluoropolyether group include a perfluoropolyether group represented by the following Formula (4′):

—(CF₂)_{g}—O—(CF₂O)_{b}(CF₂CF₂O)_{c}(CF₂CF₂CF₂O)_{d}(CF₂CF₂CF₂CF₂O)ₑ(CF₂CF(CF₃)O)_{f}—(CF₂)ₕ— (4)

where b′, c′, d′, e′, and f′ are each independently a real number of 0 to 30, and more preferably a real number of 0 to 25, in each Rf′. Note, however, that at least any one of b′, c′, d′, e′, and f′ is a real number of not less than 1. g‘ and h’ are each independently an integer of 0 to 3 in each Rf′. Note here that values of b′, c′, d′, e′, and f′ are calculated as in the case of the values of b, c, d, e, and f in the Formula (4).

Examples of the Rf′ include perfluoropolyether groups each including at least one selected from the group consisting of: Demnum backbone (C3 backbone): —(CF₂CF₂CF₂O)_{d}—, Fomblin backbone (C1C2 backbone): —(CF₂O)_{b}′(CF₂CF₂O)_{c}′—, C2 backbone: —(CF₂CF₂O)_{c}′—, C4 backbone: —(CF₂CF₂CF₂CF₂O)ₑ′—, and Krytox backbone: —(CF₂CF(CF₃)O)_{f}′—.

More preferable examples of the Rf′ include groups similar to the group that is any of (i) to (v) listed in Rf in the Formula (1). Note here that in a case where a part corresponding to Rf in Formula (1) contains a fluoroether group and/or a perfluoroalkyl group which has/have been produced by fluorine substitution in the fluorination step, Rf in the Formula (1) may be different from the Rf′.

R¹¹, R¹², and R¹³ in Formula (2) are not particularly limited provided that R¹¹, R¹², and R¹³ in Formula (2) are each independently a hydrocarbon group having at least one OH group or at least one cyclic hydrocarbon group. The hydrocarbon group having at least one OH group may be a hydrocarbon group having one OH group or may be a hydrocarbon group having two or more OH groups. The hydrocarbon group may contain at least one OH group and at least one cyclic hydrocarbon group.

R¹¹ in Formula (2) can be identical to R¹ in the Formula (1). R¹² and R¹³ in Formula (2) can be identical to R² and R³ in the Formula (1).

L¹¹, L¹², L¹³, and L¹⁴ in Formula (2) can be identical to L¹, L², L³, and L⁴ in the Formula (1). R¹⁴ can be identical to R⁴ in the Formula (1). p, q, x, and y in Formula (2) are identical to p, q, x, and y in Formula (1).

<Method for Producing Perfluoropolyether Derivative>

(Production Method (1))

A method for producing the perfluoropolyether derivative is not particularly limited. A perfluoropolyether derivative R¹¹—Rf′—R¹² that has p=0 and q=0 in Formula (2) can be produced by, for example, reacting perfluoropolyether (A) having OH groups at both terminals of a molecule with an epoxide derivative having an OH group and/or a cyclic hydrocarbon group.

The perfluoropolyether (A) having OH groups at both terminals of a molecule can be exemplified by, but is not limited to, HO—CH₂—Rf′—CH₂—OH provided that the perfluoropolyether (A) is a compound having OH groups at both terminals of the Rf′. Note here that Rf′ is identical to Rf′ in the Formula (2). More specific examples of the perfluoropolyether (A) having OH groups at both terminals of a molecule are not limited to but include HOCH₂CF₂O(CF₂CF₂O)_{c}′CF₂CH₂OH and HOCH₂CF₂CF₂O(CF₂CF₂CF₂O)_{d}′CF₂CF₂CH₂OH. Note here that c′ has a value of preferably 1 to 25, more preferably 4 to 14, d′ has a value of preferably 1 to 20, and more preferably 2 to 12, and values of c‘ and d’ are values calculated according to the above-described method by ¹⁹F-NMR measurement with use of JNM-ECX400 available from JEOL Ltd.

The perfluoropolyether (A) having OH groups at both terminals of a molecule has a number average molecular weight that is not limited to but is preferably 150 to 6,000, more preferably 400 to 2,500, and even more preferably 500 to 1,200. Note here that the number average molecular weight is a value measured according to the above-described method by ¹⁹F-NMR with use of JNM-ECX400 available from JEOL Ltd.

The perfluoropolyether (A) having OH groups at both terminals of a molecule is a compound having a molecular weight distribution. The compound has a molecular weight distribution (PD) of preferably 1.0 to 1.5, more preferably 1.0 to 1.3, and even more preferably 1.0 to 1.1, the molecular weight distribution (PD) being represented by weight average molecular weight/number average molecular weight. Note that the molecular weight distribution is a property value obtained with use of HPLC-8220GPC available from TOSOH CORPORATION, a column (PLgel Mixed E) available from Polymer Laboratories, an HCFC-based substitute for CFCs as an eluent, and non-functional perfluoropolyether as a reference substance.

The epoxide derivative having an OH group and/or a cyclic hydrocarbon group is not particularly limited provided that the epoxide derivative reacts with the perfluoropolyether (A) having OH groups at both terminals of a molecule so as to form R¹¹—Rf′—R¹². Examples of the epoxide derivative having an OH group include glycidol, 3-(2-oxiranylmethoxy)-1,2-propanediol, and 2-(2-oxiranylmethoxy)ethanol. Examples of the epoxide derivative having a cyclic hydrocarbon group include 2-[(4-methoxyphenoxy)methyl]-oxirane, 2-[(4-ethoxyphenoxy)methyl]-oxirane, 2-[(4-propoxyphenoxy)methyl]-oxirane, 2-[(4-butoxyphenoxy)methyl]-oxirane, 2-[(4-nitrophenoxy)methyl]-oxirane, and 2-[(phenoxy)methyl]-oxirane.

The epoxide derivative having an OH group and/or a cyclic hydrocarbon group is used in an amount of preferably 150 mol % to 300 mol %, and more preferably 200 mol % to 250 mol %, with respect to the perfluoropolyether (A) having OH groups at both terminals of a molecule. In a case where the epoxide derivative having an OH group and/or a cyclic hydrocarbon group is used in an amount in the above range, it is possible to obtain a desired perfluoropolyether derivative.

A reaction between the perfluoropolyether (A) having OH groups at both terminals of a molecule and the epoxide derivative having an OH group and/or a cyclic hydrocarbon group is preferably carried out in the presence of a base. The base can be, for example, potassium t-butoxide, sodium t-butoxide, sodium hydroxide, or potassium hydroxide. The reaction is carried out at a reaction temperature of preferably 25° C. to 110° C., and more preferably 40° C. to 80° C. The reaction is carried out for a reaction time of preferably 2 hours to 48 hours, and more preferably 10 hours to 24 hours.

The reaction is more preferably carried out in an atmosphere of an inert gas such as argon, nitrogen, or helium. The reaction may be carried out in a solvent. The solvent can be, for example, dichloromethane, t-butyl alcohol, toluene, dimethyl sulfoxide, or tetrahydrofuran.

A perfluoropolyether derivative that has p=0 and q=0 in Formula (2) can be obtained by reacting the perfluoropolyether (A) having OH groups at both terminals of a molecule with the epoxide derivative having an OH group and/or a cyclic hydrocarbon group, then neutralizing a resulting reaction product with an acid such as hydrochloric acid, nitric acid, or sulfuric acid, water-washing and dehydrating the neutralized reaction product, and purifying the reaction product by silica gel chromatography or the like.

(Production Method (2))

Examples of a method for producing a perfluoropolyether derivative R¹¹—Rf′-(L¹³-Rf′)_{q}—R¹² that has p=0 and q≥1 in Formula (2) include a production method including the steps of: (i) reacting the perfluoropolyether (A) having OH groups at both terminals of a molecule with a predetermined amount of an epoxide derivative having an OH group and/or a cyclic hydrocarbon group so as to cause a reaction between an OH group at one terminal of the perfluoropolyether (A) and the epoxide derivative so that a compound in which R¹¹ is bonded to one terminal of the perfluoropolyether (A) and a compound in which R¹² is bonded to one terminal of the perfluoropolyether (A) are obtained; and (ii) obtaining the perfluoropolyether derivative R¹¹—Rf′-(L¹³-Rf′)_{q}—R¹² by reacting the compounds obtained in (i) with a compound in which a linking group L¹³ has, at both terminals thereof, structures each reacting with an OH group so as to be bonded to the OH group. The following description will discuss the steps (i) and (ii).

In the step (i), a reaction between the perfluoropolyether (A) having OH groups at both terminals of a molecule and a predetermined amount of the epoxide derivative having an OH group and/or a cyclic hydrocarbon group is preferably carried out in the presence of a base. In the step (i), the perfluoropolyether (A) having OH groups at both terminals of a molecule, the epoxide derivative having an OH group and/or a cyclic hydrocarbon group, the base, a reaction temperature, a reaction time, a reaction atmosphere, and a solvent are identical to those in the foregoing “Production method (1)”.

In the step (i), the epoxide derivative having an OH group and/or a cyclic hydrocarbon group is used in an amount of preferably 10 mol % to 80 mol %, and more preferably 20 mol % to 60 mol %, with respect to the perfluoropolyether (A) having OH groups at both terminals of a molecule. In a case where the epoxide derivative having an OH group and/or a cyclic hydrocarbon group is used in an amount in the above range, it is possible to obtain a desired perfluoropolyether derivative in which R¹¹ or R¹² is bonded to one terminal of the perfluoropolyether (A).

Examples of the compound which is used in the step (ii) and in which the linking group L¹³ has, at both terminals thereof, structures each reacting with an OH group so as to be bonded to the OH group include a diepoxide compound having epoxide structures at both terminals of a hydrocarbon group, which is the linking group L¹³, and an α, ω-dihaloalkyl alcohol compound. Examples of the diepoxide compound include 1,3-butadiene diepoxide, 1,4-pentadiene diepoxide, 1,5-hexadiene diepoxide, 1,6-heptadiene diepoxide, 1,7-octadiene epoxide, 1,8-nonanediene diepoxide, and 1,9-decanediene diepoxide. Note here that the compound in which the linking group L¹³ has, at both terminals thereof, structures each reacting with an OH group so as to be bonded to the OH group is used in an amount of preferably 40 mol % to 280 mol %, and more preferably 80 mol % to 240 mol %, with respect to the perfluoropolyether derivative obtained in (i). In a case where the compound in which the linking group L¹³ has, at both terminals thereof, structures each reacting with an OH group so as to be bonded to the OH group is used in an amount in the above range, it is possible to obtain a desired perfluoropolyether derivative.

In the step (ii), a reaction between the compounds obtained in (i) and the compound in which the linking group L¹³ has, at both terminals thereof, structures each reacting with an OH group so as to be bonded to the OH group is preferably carried out in the presence of a base. The base can be, for example, potassium t-butoxide, sodium t-butoxide, sodium hydroxide, or potassium hydroxide. The reaction is carried out at a reaction temperature of preferably 25° C. to 110° C., and more preferably 40° C. to 80° C. The reaction is carried out for a reaction time of preferably 2 hours to 48 hours, and more preferably 10 hours to 24 hours.

The reaction is more preferably carried out in an atmosphere of an inert gas such as argon, nitrogen, or helium. The reaction may be carried out in a solvent. The solvent can be, for example, t-butanol, toluene, or xylene.

The perfluoropolyether derivative R¹¹—Rf′-(L¹³-Rf)_{q}—R¹² that has p=0 and q≥1 in Formula (2) can be obtained by reacting the perfluoropolyether derivative obtained in (i) with the compound in which the linking group L¹³ has, at both terminals thereof, structures each reacting with an OH group so as to be bonded to the OH group, then neutralizing a resulting reaction product with an acid such as hydrochloric acid, nitric acid, or sulfuric acid, water-washing and dehydrating the neutralized reaction product, and purifying the reaction product by silica gel chromatography or the like. A value of q is a mean value calculated according to the above-described method by ¹H-NMR measurement with use of JNM-ECX400 available from JEOL Ltd., and is a real number.

(Production Method (3))

Examples of a method for producing a perfluoropolyether derivative that has (i) p=1 and q=0 and x=1 and y=1 or (ii) p=1 and q=0 and x=2 and y=0 in Formula (2) include a production method including the steps of: (i) reacting the perfluoropolyether (A) having OH groups at both terminals of a molecule with a predetermined amount of an epoxide derivative having an OH group and/or a cyclic hydrocarbon group so as to cause a reaction between an OH group at one terminal of the perfluoropolyether (A) and the epoxide derivative so that a compound in which R¹¹, R¹², or R¹³ is bonded to one terminal of the perfluoropolyether (A) is obtained; and (ii) obtaining a perfluoropolyether derivative R¹¹—Rf′-L¹¹-C(L¹⁴)ₓ(R¹⁴)_{y}-L¹²-Rf′—R¹² by reacting the compound obtained in (i) with a compound in which L¹¹, L¹⁴, and L¹² of a linking group L¹¹-C(L¹⁴)ₓ(R¹⁴)_{y}-L¹² have, at respective terminals thereof, structures each reacting with an OH group so as to be bonded to the OH group. The following description will discuss the steps (i) and (ii).

In the step (i), a reaction between the perfluoropolyether (A) having OH groups at both terminals of a molecule and a predetermined amount of the epoxide derivative having an OH group and/or a cyclic hydrocarbon group is preferably carried out in the presence of a base. In the step (i), the perfluoropolyether (A) having OH groups at both terminals of a molecule, the epoxide derivative having an OH group and/or a cyclic hydrocarbon group, the base, a reaction temperature, a reaction time, a reaction atmosphere, and a solvent are identical to those in the foregoing “Production method (1)”.

In the step (i), the epoxide derivative having an OH group and/or a cyclic hydrocarbon group is used in an amount of 10 mol % to 80 mol %, and more preferably 20 mol % to 60 mol %, with respect to the perfluoropolyether (A) having OH groups at both terminals of a molecule. In a case where the epoxide derivative having an OH group and/or a cyclic hydrocarbon group is used in an amount in the above range, it is possible to obtain a desired perfluoropolyether derivative in which R¹¹, R¹², or R¹³ is bonded to one terminal of the perfluoropolyether (A).

The compound which is used in the step (ii) and in which L¹¹, L¹⁴, and L¹² of the linking group L¹¹-C(L¹⁴)ₓ(R¹⁴)_{y}-L¹² have, at respective terminals thereof, structures each reacting with an OH group so as to be bonded to the OH group can be exemplified by, but is not limited to, 2,2′-[[2-ethyl-2-[(2-oxiranylmethoxy)methyl]-1,3-propanediyl]bis(oxymethylene)]bis-oxirane represented by the following Formula (9):

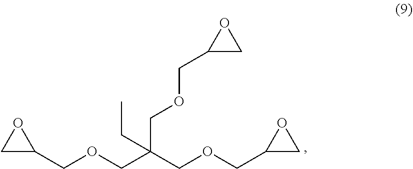 [SMILES: CCC(COCC1CO1)(COCC1CO1)COCC1CO1]

and 2,2′-[[2,2-bis[(2-oxiranylmethoxy)methyl]-1,3-propanediyl]bis(oxymethylene)]bis-oxirane represented by the following Formula (10):

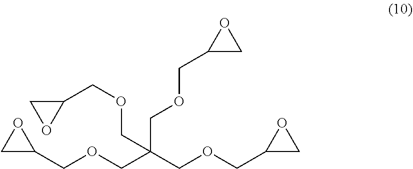 [SMILES: C(OCC(COCC1CO1)(COCC1CO1)COCC1CO1)C1CO1]

Note here that the compound in which L¹¹, L¹⁴, and L¹² of the linking group L¹¹-C(L¹⁴)ₓ(R¹⁴)_{y}-L¹² have, at respective terminals thereof, structures each reacting with an OH group so as to be bonded to the OH group is used in an amount of preferably 10 mol % to 150 mol %, and more preferably 10 mol % to 50 mol %, with respect to the compound obtained in (i). In a case where the compound is used in an amount in the above range, it is possible to obtain a desired perfluoropolyether derivative.

In the step (ii), a reaction between the compound obtained in (i) and the compound in which L¹¹, L¹⁴, and L¹² of the linking group L¹¹-C(L¹⁴)ₓ(R¹⁴)_{y}-L¹² have, at respective terminals thereof, structures each reacting with an OH group so as to be bonded to the OH group is preferably carried out in the presence of a base. The base can be, for example, potassium t-butoxide, sodium t-butoxide, sodium hydroxide, or potassium hydroxide. The reaction is carried out at a reaction temperature of preferably 25° C. to 110° C., and more preferably 40° C. to 80° C. The reaction is carried out for a reaction time of preferably 2 hours to 48 hours, and more preferably 10 hours to 24 hours.

The reaction is more preferably carried out in an atmosphere of an inert gas such as argon, nitrogen, or helium. The reaction may be carried out in a solvent. The solvent can be, for example, t-butanol, toluene, xylene, or methaxylene hexafluoride.

The perfluoropolyether derivative that has (i) p=1 and q=0 and x=1 and y=1 or (ii) p=1 and q=0 and x=2 and y=0 in Formula (2) can be obtained by reacting the compound obtained in (i) with the compound in which L¹¹, L¹⁴, and L¹² of the linking group L¹¹-C(L¹⁴)ₓ(R¹⁴)_{y}-L¹² have, at respective terminals thereof, structures each reacting with an OH group so as to be bonded to the OH group, then neutralizing a resulting reaction product with an acid such as hydrochloric acid, nitric acid, or sulfuric acid, water-washing and dehydrating the neutralized reaction product, and purifying the reaction product by silica gel chromatography or the like.

<Esterification Step>

In the present step, ester is introduced into the compound represented by the Formula (2) (perfluoropolyether derivative) so that perfluoropolyether derivative ester is obtained. Examples of a method of introducing the ester include a method of reacting the perfluoropolyether derivative with an acid anhydride in the presence of a base.

The acid anhydride can be, for example, acetic anhydride or propionic anhydride. The base can be, for example, pyridine or triethylamine.

Esterification of an OH group of the perfluoropolyether derivative by reacting the perfluoropolyether derivative with the acid anhydride in the presence of the base enables the OH group of the perfluoropolyether derivative to be protected in the fluorination step described later.

The reaction is carried out at a reaction temperature of, for example, 0° C. to 60° C., and more preferably 15° C. to 40° C. The reaction is carried out for a reaction time of preferably 3 hours to 48 hours and more preferably 5 hours to 20 hours.

After the perfluoropolyether derivative is reacted with the acid anhydride, resulting perfluoropolyether derivative ester can be purified by, for example, distilling off the base and the acid under reduced pressure. The base and the acid are distilled off under reduced pressure at a temperature of preferably 60° C. to 80° C., and more preferably 65° C. to 75° C.

<Fluorination Step>

In the present step, the perfluoropolyether derivative ester obtained in the esterification step is fluorinated. In the present step, a method of fluorinating the perfluoropolyether derivative ester is exemplified by, but not particularly limited to, a method including: a step (step I) of introducing the perfluoropolyether derivative ester, fluorine gas, inert gas, and a solvent into a reactor and reacting a resulting solution; and a step (step II) of introducing alcohol into the reactor after the step I.

It can be said that in the above method, fluorination is carried out in a liquid phase fluorine substitution reactor. Note here that fluorination, i.e., a fluorine substitution reaction is preferably carried out by using, as the solvent, a fully halogen-substituted liquid, e.g., a perfluorocarbon, fully halogen-substituted chlorofluorocarbon, or fully halogen-substituted chlorofluoroether. Such a solvent is exemplified by, but not limited to, 1,1,2-chlorotrifluoroethane.

The step I is not particularly limited provided that the step I is a step of introducing the perfluoropolyether derivative ester, fluorine gas, inert gas, and a solvent into a reactor and reacting a resulting solution. For example, the step I can be carried out according to the following procedure.
i) The solvent is introduced into the reactor.
ii) The perfluoropolyether derivative ester is diluted with the solvent and introduced into the reactor at an appropriate speed.
iii) Fluorine gas and inert gas are introduced into the reactor.

In the above i), air in the reactor is preferably substituted with inert gas by purging the reactor with inert gas before a reaction is started. The inert gas is exemplified by, but not particularly limited to, nitrogen, helium, and argon. The reactor is purged for a time that is not limited to but is, for example, 10 minutes to 2 hours, and more preferably 20 minutes to 40 minutes.

During the reaction, a temperature in the reactor is preferably −40° C. to 150° C., and more preferably −10° C. to 50° C. The temperature in the reactor is more preferably maintained in the above range throughout the fluorine substitution reaction.

In the above ii), a solvent for diluting the perfluoropolyether derivative ester may be any solvent provided that the solvent is any of the above-listed solvents. The solvent for diluting the perfluoropolyether derivative ester may be identical to or different from the solvent that is introduced into the reactor in the above i). From the viewpoint of ease of removal, the solvent for diluting the perfluoropolyether derivative ester is more preferably identical to the solvent that is introduced into the reactor in the above i).

A dilution ratio at which the perfluoropolyether derivative ester is diluted with the solvent is not particularly limited. For example, an amount of the perfluoropolyether derivative ester is 10 mass % to 80 mass %, and more preferably 20 mass % to 50 mass %, with respect to a total amount of the perfluoropolyether derivative ester and the solvent after dilution.

The perfluoropolyether derivative ester diluted with the solvent is introduced into the reactor at a speed that is not particularly limited and only needs to be selected as appropriate in accordance with a size of the reactor and/or amounts of the perfluoropolyether derivative ester, fluorine gas, inert gas, and the solvent.

The fluorine gas is introduced in the above iii) in an amount that is not particularly limited but is, for example, 1 equivalent to 5 equivalents, and more preferably 1 equivalent to 1.5 equivalents, with respect to hydrogen to be substituted with fluorine. The present step is ordinarily used to substitute all hydrogen atoms in a molecule with fluorine. In a case where some of hydrogen atoms in a molecule are to be substituted with fluorine, introduction of fluorine gas whose amount is substantially equal to an amount of hydrogen atoms desired to be substituted with fluorine makes it possible to obtain a fluoropolyether compound in which some of hydrogen atoms in a molecule have been substituted with fluorine.

In the step I, a scavenger for hydrogen fluoride produced during the reaction may be used. The scavenger for hydrogen fluoride can be, for example, sodium fluoride. A method of adding the scavenger for hydrogen fluoride is not particularly limited. For example, the scavenger for hydrogen fluoride can be introduced into the reactor together with the solvent in the above (i).

In the step II, after the step I, alcohol is introduced into the reactor. More specifically, for example, after introduction of fluorine gas is completed in the step I, alcohol is introduced into the reactor. The alcohol is exemplified by, but not limited to, methanol, ethanol, and n-propanol. In terms of, for example, ease of purification, methanol is particularly preferable. A volume-based amount of the alcohol introduced is, for example, 2 times to 20 times, and more preferably 2 times to 5 times, with respect to the perfluoropolyether derivative ester.

After the alcohol is introduced into the reactor in the step II, by, for example, filtering a reaction mixture so as to remove a solid component and concentrate a liquid component, it is possible to obtain the purified fluorinated perfluoropolyether derivative ester.

<Reduction Step>

In the present step, the fluorinated perfluoropolyether derivative ester (hereinafter may be simply referred to as “fluorinated ester”) obtained in the fluorination step is reduced. A method of reducing the fluorinated ester obtained in the fluorination step is exemplified by, but not limited to, a method of using boron hydride metal to reduce the fluorinated ester.

The method of using boron hydride metal to reduce the fluorinated ester is also exemplified by, but not particularly limited to, a method of dropping, onto a mixture of alcohol and a boron hydride metal compound, the fluorinated ester obtained in the fluorination step. The fluorinated ester is preferably dropped under stirring of a mixture of alcohol and a boron hydride metal compound. The fluorinated ester is more preferably dropped while being diluted with a fluorine solvent.

The reduction step is carried out at a reaction temperature of, for example, −10° C. to 80° C., and more preferably 0° C. to 50° C., for a reaction time of, for example, 2 hours to 24 hours, and more preferably 10 hours to 20 hours.

Examples of the fluorine solvent that can be suitably used include: Novec7100, Novec7200, PF-5060, and PF-5080 each available from 3M Company; and VertrelXF available from Chemours-Mitsui Fluoroproducts Co., Ltd. In particular, Novec7100 is particularly preferable from the viewpoint of solubility and chemical stability of a substrate.

The alcohol can be selected from, for example, alcohols having 1 to 10 carbon atoms. Ethanol is particularly preferable in terms of solubility and handling of a substrate.

The boron hydride metal can be selected from, for example, a boron hydride alkali metal salt and a boron hydride alkaline earth metal salt. Sodium boron hydride is particularly preferable from the viewpoint of safety.

After the fluorinated ester is reacted with boron hydride metal, a reaction is stopped by, for example, adding hydrochloric acid, and a resulting product can be extracted from an aqueous layer with use of a fluorine solvent. In a case where such a fluorine solvent layer is concentrated and purified by distillation and/or silica gel chromatography, it is possible to obtain the fluoropolyether compound which is a target compound and in which a terminal group has been reduced to alcohol.

[2.2 Method for Fluorinating Esterified Polyalkylene Glycol Derivative]

The following description will discuss a method for producing a fluoropolyether compound in accordance with another embodiment of the present invention, wherein an esterified polyalkylene glycol derivative is fluorinated. For example, a method for producing the fluoropolyether compound in accordance with the present embodiment includes: an esterification step of introducing ester into a compound represented by the following Formula (3) (hereinafter may be referred to as a “polyalkylene glycol derivative”); a fluorination step of fluorinating the ester obtained in the esterification step (hereinafter may be referred to as “polyalkylene glycol derivative ester”); and a reduction step of reducing the fluorinated ester obtained in the fluorination step.

R²¹—Rf″—R²² (3)

where: Rf″ is a polyoxyalkylene group; and R²¹ and R²² are each a hydrocarbon group that may contain an ether bond having at least one OH group, or an OH group.

In Formula (3), Rf″ is a group in which all fluorine atoms of Rf′ in the Formula (2) are substituted with hydrogen atoms.

The polyalkylene glycol derivative is not particularly limited provided that the polyalkylene glycol derivative is the compound represented by Formula (3). In a case where R²¹ and R²² in the compound represented by the Formula (3) are each an OH group, the compound represented by the Formula (3) can be a polyalkylene glycol such as methylene glycol, ethylene glycol, propylene glycol, or butylene glycol. R²¹ and R²² each can be identical to R¹, R², R¹¹, or R¹² in the Formulas (1) and (2).

<Esterification Step>

In the present step, ester is introduced into the polyalkylene glycol derivative so that the polyalkylene glycol derivative ester is obtained. Examples of a method of introducing ester include: a method of substituting an OH group of the polyalkylene glycol derivative with a leaving group and reacting a resulting compound with diester malonate; and a method of reacting the polyalkylene glycol derivative with an acid anhydride in the presence of a base.

Examples of the leaving group with which the OH group of the polyalkylene glycol derivative is substituted include a p-toluene sulfonyl group, a trifluoromethyl sulfonyl group, a methanesulfonyl group, an iodine group, a bromo group, and a chloro group. A method of introducing the leaving group into the polyalkylene glycol derivative is not particularly limited, and a conventionally known method can be used as appropriate. Examples of a compound obtained by introducing leaving groups to both terminals of the polyalkylene glycol derivative include a compound represented by Ts-CH₂CH₂O(CH₂CH₂O)_{z}CH₂CH₂-Ts: where: Ts is a tosyl group; z is preferably a real number of 1 to 25, and more preferably a real number of 4 to 14; and z is a mean value calculated by ¹H-NMR measurement with use of JNM-ECX400 available from JEOL Ltd. In the NMR measurement, a sample was diluted with deuterated chloroform and used for measurement.

A method of reacting the compound obtained by introducing leaving groups to both terminals of the polyalkylene glycol derivative with diester malonate is exemplified by, but not particularly limited to, a method of reacting the compound with diester malonate in the presence of a base. The diester malonate can be, for example, diethyl malonate or dimethyl malonate. The base can be, for example, potassium t-butoxide, sodium t-butoxide, sodium hydroxide, or potassium hydroxide. The reaction is carried out at a reaction temperature of preferably 0° C. to 100° C., and more preferably 40° C. to 80° C. The reaction is carried out for a reaction time of preferably 2 hours to 24 hours, and more preferably 5 hours to 20 hours. Thus, the leaving group of the polyalkylene glycol derivative leaves, and ester is introduced.

The reaction is more preferably carried out in an atmosphere of an inert gas such as argon, nitrogen, or helium. The reaction may be carried out in a solvent. The solvent can be, for example, dichloromethane, t-butyl alcohol, toluene, dimethyl sulfoxide, or tetrahydrofuran.

After the polyalkylene glycol derivative ester is obtained by reacting the compound obtained by introducing leaving groups to both terminals of the polyalkylene glycol derivative with diester malonate, for example, the polyalkylene glycol derivative ester can be neutralized with an acid such as ammonium chloride, water-washed and dehydrated, and purified by silica gel chromatography or the like.

A method of reacting the polyalkylene glycol derivative with the acid anhydride in the presence of a base is identical to the esterification step of [2.1 Method for fluorinating esterified perfluoropolyether derivative] described earlier.

<Fluorination Step and Reduction Step>

Since the fluorination step and the reduction step are identical to the case of [2.1 Method for fluorinating esterified perfluoropolyether derivative], a description thereof is omitted here.

[3. Lubricant]

A lubricant in accordance with an embodiment of the present invention contains the above-described fluoropolyether compound in accordance with an embodiment of the present invention. The above-described fluoropolyether compound can be used alone as the lubricant. Alternatively, the fluoropolyether compound and any other component that are mixed at an arbitrary ratio can be used as the lubricant provided that performance of the lubricant is not impaired.

The lubricant in accordance with an embodiment of the present invention contains the fluoropolyether compound represented by Formula (1), in an amount of not less than 50 mass %, more preferably not less than 80 mass %, and even more preferably not less than 90 mass %.

Examples of the any other component include fluorine oils such as Fomblin (registered trademark) Zdol (available from Solvay Solexis), Ztetraol (available from Solvay Solexis), Demnum (registered trademark) (available from Daikin Industries, Ltd.), Krytox (registered trademark) (available from DuPont), MORESCO PHOSFAROL A20H (available from MORESCO Corporation), and MORESCO PHOSFAROL D-40H (available from MORESCO Corporation).

The lubricant can be used as a lubricant for recording media, in order to improve sliding properties of magnetic disks. The lubricant can also be used as a lubricant for recording media not only in magnetic disks but also in other recording devices (e.g., magnetic tapes) that involve sliding between the recording media and heads. The lubricant can also be used as a lubricant not only for recording devices but also for devices having a part that involves sliding.

[4. Magnetic Disk]

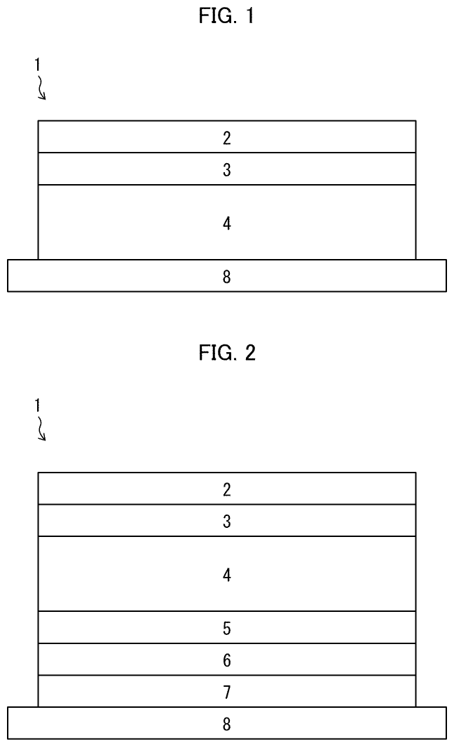

A magnetic disk 1 in accordance with an embodiment of the present invention includes, as illustrated in FIG. 1, a recording layer 4, a protective film layer (protective layer) 3, and a lubricant layer 2, which are disposed on a non-magnetic substrate 8. The lubricant layer 2 contains the above-described lubricant.

In another embodiment, as in a magnetic disk 1 illustrated in FIG. 2, a magnetic disk can include a lower layer 5 that underlies the recording layer 4, one or more soft magnetic lower layers 6 that underlie the lower layer 5, and an adhesive layer 7 that underlies the one or more soft magnetic lower layers 6. In an embodiment, all these layers can be formed on a non-magnetic substrate 8.

Each of the layers of the magnetic disk 1 except the lubricant layer 2 can contain a material that is known, in the technical field to which the present invention pertains, to be suitable for a corresponding layer of a magnetic disk. Examples of the material of the recording layer 4 include: an alloy of an element (e.g., iron, cobalt, or nickel), from which a ferromagnetic material can be formed, and chromium, platinum, tantalum, or the like; and an oxide of the alloy.

Examples of the material of the protective layer 3 include carbon, Si₃N₄, SiC, and SiO₂. Examples of the material of the non-magnetic substrate 8 include an aluminum alloy, glass, and polycarbonate.

[5. Method for Producing Magnetic Disk]

A method for producing a magnetic disk in accordance with an aspect of the present invention includes a step of forming a lubricant layer by placing the lubricant in accordance with an embodiment of the present invention on an exposed surface of a protective layer of a stack of a recording layer and the protective layer.

There is no particular limitation on a method of forming the lubricant layer by placing the lubricant on the exposed surface of the protective layer of the stack of the recording layer and the protective layer. The lubricant is preferably placed on the exposed surface of the protective layer by, for example, immersing the magnetic disk in a solution obtained by diluting the lubricant with a solvent. Examples of the solvent include: PF-5060, PF-5080, Novec7100, and Novec7200 each available from 3M Company; and Vertrel-XF (registered trademark) available from DuPont. The lubricant having been diluted with the solvent has a concentration of preferably 0.001 mass % to 1 mass %, more preferably 0.005 mass % to 0.5 mass %, and even more preferably 0.005 mass % to 0.1 mass %. In a case where the lubricant having been diluted with the solvent has a concentration of 0.005 mass % to 0.1 mass %, it is possible to weaken the interaction among molecules of the lubricant. This makes it easy to form a uniform lubricating film.

After the recording layer and the protective layer are formed in this order and the lubricant is placed on the exposed surface of the protective layer, ultraviolet irradiation or heat treatment may be carried out.

By carrying out ultraviolet irradiation or heat treatment, it is possible to form stronger bonds between the lubricant layer and the exposed surface of the protective layer, and consequently to prevent the lubricant from being evaporated by heating. Ultraviolet irradiation is preferably carried out with use of ultraviolet light having a dominant wavelength of 185 nm or 254 nm. Heat treatment is carried out at a temperature of preferably 60° C. to 170° C., more preferably 80° C. to 170° C., and even more preferably 80° C. to 150° C.

The present invention is not limited to the embodiments, but can be altered by a skilled person in the art within the scope of the claims. The present invention also encompasses, in its technical scope, any embodiment derived by combining technical means disclosed in differing embodiments.

That is, an embodiment of the present invention includes the following invention:

<1> A fluoropolyether compound represented by the following Formula (1):

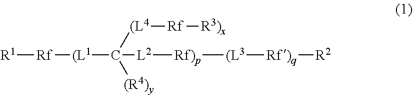

where: Rf are each independently a perfluoropolyether group;

R¹ is a hydrocarbon group having two or more OH groups, or a hydrocarbon group having at least one cyclic hydrocarbon group;

R² and R³ are each independently a hydrocarbon group having at least one OH group, or a hydrocarbon group having at least one cyclic hydrocarbon group;

L¹, L², L³, and L⁴ are each independently a hydrocarbon group, and the hydrocarbon group may contain an OH group and/or an ether bond;

R⁴ is a hydrogen atom or a hydrocarbon group, and the hydrocarbon group may contain an OH group and/or an ether bond;

p is an integer of 0 to 1, q is a real number of 0 to 10, and when p=1, (i) x=1 and y=1 or (ii) x=2 and y=0;

in a molecule, a hydrogen atom bonded to a carbon atom contained in a hydrocarbon group may be substituted with a fluorine atom; and

at least any one of R¹, R², and R³ may contain an ether bond obtained by substituting at least one carbon atom with an oxygen atom, and at least one hydrogen atom bonded to a carbon atom adjacent to the oxygen atom of the ether bond is substituted with a fluorine atom.

<2> The fluoropolyether compound described in <1>, wherein

R¹ is a hydrocarbon group having carbon atoms 2 to 10 and having two or more OH groups, or a hydrocarbon group having 3 to 25 carbon atoms and having at least one cyclic hydrocarbon group,

R² and R³ are each independently a hydrocarbon group having 1 to 10 carbon atoms and having at least one OH group, or a hydrocarbon group having 3 to 25 carbon atoms and having at least one cyclic hydrocarbon group, and at least any one of R¹, R², and R³ may contain an ether bond obtained by substituting at least one carbon atom with an oxygen atom.

<3> The fluoropolyether compound described in <1> or <2>, wherein L¹, L², L³, and L⁴ are hydrocarbon groups having 1 to 25 carbon atoms, and the hydrocarbon groups each may independently have at least one OH group and/or contain an ether bond.

<4> The fluoropolyether compound described in any one of <1> to <3>, wherein in a case where at least any one of R¹, R², and R³ contains at least one ether bond, all hydrogen atoms bonded to a carbon atom adjacent to an oxygen atom of the at least one ether bond are substituted with fluorine atoms.

<5> The fluoropolyether compound described in any one of <1> to <4>, wherein in a case where at least any one of R¹, R², and R³ contains at least one ether bond, all hydrogen atoms bonded to a carbon atom adjacent to an oxygen atom of all the at least one ether bond are substituted with fluorine atoms.

<6> The fluoropolyether compound described in any one of <1> to <5>, wherein in a case where at least any one of L¹, L², L³, L⁴, and R⁴ contains at least one ether bond, all hydrogen atoms bonded to a carbon atom adjacent to an oxygen atom of all the at least one ether bond are substituted with fluorine atoms.

<7> The fluoropolyether compound described in any one of <1> to <6>, wherein all hydrogen atoms bonded to carbon atoms other than carbon atoms bonded to the OH groups of R¹, R², R³, R⁴, L¹, L², L³, and L⁴ are substituted with fluorine atoms.

<8> A lubricant containing a fluoropolyether compound described in any one of <1> to <7>.

<9> A magnetic disk including:

a recording layer;

a protective layer disposed on the recording layer; and

a lubricant layer disposed on the protective layer,

the lubricant layer containing a lubricant described in <8>.

<10> A method for producing a fluoropolyether compound, including:

an esterification step of introducing ester into a compound;

a fluorination step of fluorinating the ester obtained in the esterification step; and

a reduction step of reducing the fluorinated ester obtained in the fluorination step,

the compound being represented by the following Formula (2):

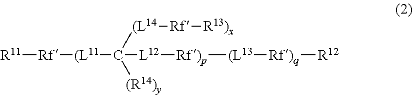

where: Rf′ are each independently a perfluoropolyether group;

R¹¹, R¹², and R¹³ are each independently a hydrocarbon group having at least one OH group;

L¹¹, L¹², L¹³, and L¹⁴ are each independently a hydrocarbon group, and the hydrocarbon group may contain an OH group and/or an ether bond;

R¹⁴ is a hydrocarbon group or a hydrogen atom, and the hydrocarbon group may have an OH group and/or contain an ether bond;

at least any one of R¹¹, R¹², and R¹³ contains an ether bond obtained by substituting at least one carbon atom with an oxygen atom; and

p is an integer of 0 to 1, q is a real number of 0 to 10, and when p=1, (i) x=1 and y=1 or (ii) x=2 and y=0.

### EXAMPLES

The present invention will be described below in more detail with reference to Examples. Note, however, that the present invention is not limited to such Examples.

### Example 1: Synthesis of HOCH₂CH(OH)CF₂OCF₂CF₂O(CF₂CF₂O)_{c},CF₂CF₂OCF₂CH(OH)C H₂OH (compound 1)

In an argon atmosphere, 500 g of HOCH₂CF₂O(CF₂CF₂O)_{c}·CF₂CH₂OH (number average molecular weight: 1,048) and 94 g of glycidol were stirred in a solvent (243 g of t-butyl alcohol) at 70° C. for 22 hours in the presence of 11 g of potassium t-butoxide, so that a crude product was obtained. Thereafter, 60 g of a 3% aqueous nitric acid solution was added to a resulting crude product-containing mixture, and the resulting crude product-containing mixture was neutralized, water-washed, and dehydrated. A resulting crude product was purified by silica gel chromatography, so that 513 g of the following compound 1-2 was obtained in which an OH group at a terminal of perfluoropolyether was substituted with a dihydroxypropoxy group.

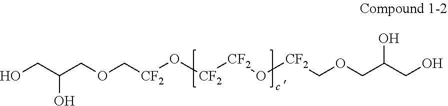

In a round-bottom recovery flask, 500 g of this compound (compound 1-2) was placed, and 380 g of pyridine was added while the compound was stirred. To a resulting mixture, 440 g of acetic anhydride was dropped, and the mixture was stirred at room temperature overnight. Thereafter, a reaction mixture was concentrated and dried with use of an evaporator, so that 510 g of a compound in which an OH group of the compound 1-2 was acetlated was obtained.

In a 5 L reaction vessel, 1.9 L of 1,1,2-trichlorotrifluoroethane and 1,320 g of sodium fluoride were placed. 300 g of the compound in which an OH group of the compound 1-2 was acetylated was diluted with 1,1,2-trichlorotrifluoroethane so that a post-dilution volume of 710 mL was obtained. A flow of nitrogen to be introduced into the reaction vessel was set at 3,400 mL/min, and a flow of fluorine to be introduced into the reaction vessel was set at 800 mL/min. The compound which was diluted with 1,1,2-trichlorotrifluoroethane and in which an OH group of the compound 1-2 was acetylated was added to the reaction vessel at a rate of 0.5 mL/min while a temperature of the reaction vessel was maintained at 0° C. After a diluted solution was added, the flow of nitrogen was lowered to 1500 mL/min, and the flow of fluorine was lowered to 300 mL/min. An appropriate amount of fluorine was introduced while the temperature of the reaction vessel was maintained at 0° C. and while the flow of nitrogen and the flow of fluorine were maintained for 30 minutes. Thereafter, introduction of fluorine was stopped. Subsequently, the reaction vessel was purged with nitrogen, and then 112 g of methanol was added to this reaction vessel. A solid was filtered out of a resulting reaction mixture, and a filtrate was concentrated and purified by distillation, so that 420 g of a perfluoro compound having a methylesterified terminal was obtained.

In a 4 L four-neck flask, a mixed solution of 91 g of sodium boron hydride and 800 g of ethanol was placed. Into the four-neck flask, 400 g of the perfluoro compound diluted with 800 g of Novec7100 (available from 3M Company) and having a methylesterified terminal was dropped at a rate of 5 g/min and then stirred at 40° C. for 16 hours. In the four-neck flask, 400 g of 3% hydrochloric acid was added so as to stop a reaction, and a target compound dissolved in Novec7100 was separated from a water layer and extracted. A crude product was obtained by concentrating and drying an extraction layer. Thereafter, the crude product was purified by column chromatography and distillation, so that 118 g of the compound 1 whose terminal group was reduced to an alcohol group was obtained. The compound 1 was a waxy white solid, and had a density of 1.7 g/cm³ at 20° C. The compound 1 was subjected to NMR measurement, and a structure thereof was identified by the following result. ¹⁹F-NMR (solvent: deuterated methanol, reference: OCF₂CF₂O in the product was regarded as −89.1 ppm.)

δ=−80.6 ppm[2F], δ=−81.5 ppm[2F], δ=−89.1 ppm[31F]

A result of ¹⁹F-NMR has shown that the compound 1 has c=6.1.

¹H-NMR (solvent: deuterated methanol, reference substance: residual protons in deuterated methanol) δ=3.6 ppm[2H], δ=3.7 ppm[2H], δ=4.0 ppm[2H].

Note that a repeating unit c in Formula (4) of the compound 1 is larger by 2 than a repeating unit c′ in Formula (4′) of the compound 1-2, which is a raw material.

### Example 2: Synthesis of (HOCH₂)₂CFCF₂CF₂OCF₂CF₂O(CF₂CF₂O)_{c},CF₂CF₂OCF₂CF₂CF(C H₂OH)₂ (compound 2)

In an argon atmosphere, 255 g of p-toluenesulfonyl chloride diluted with 800 g of dichloromethane was dropped into a system obtained by mixing 300 g of HO(CH₂CH₂O)_{c},H (number average molecular weight: 533) and 171 g of triethylamine in a solvent (dichloromethane 600 g) at 0° C. After dropping, a resulting mixture was reacted at room temperature for 15 hours, and then 300 mL of a saturated aqueous sodium hydrogen carbonate solution was added. Thereafter, a resulting crude product was water-washed, dehydrated, and purified by silica gel column chromatography, so that 345 g of polyethylene glycol having a tosyl group terminal was obtained.

In an argon atmosphere, 300 g of polyethylene glycol having a tosyl group terminal was dropped into a mixed solution of 675 g of t-butyl alcohol, 43 g of potassium t-butoxide, and 59 g of diethyl malonate. Thereafter, a resulting solution was stirred at 70° C. for 15 hours. To a resulting reaction mixture, 600 mL of a saturated aqueous ammonium chloride solution and 525 g of dichloromethane were added, and a resulting solution was water-washed, dehydrated, and purified by silica gel column chromatography, so that 154 g of polyethylene glycol derivative ester was obtained.

In a 3 L reaction vessel, 900 mL of 1,1,2-trichlorotrifluoroethane and 615 g of sodium fluoride were placed. 140 g of the polyethylene glycol derivative ester was diluted with 1,1,2-trichlorotrifluoroethane so that a post-dilution volume of 350 mL was obtained. A flow of nitrogen to be introduced into the reaction vessel was set at 3,400 mL/min, and a flow of fluorine to be introduced into the reaction vessel was set at 800 mL/min. The polyethylene glycol derivative ester diluted with 1,1,2-trichlorotrifluoroethane was added to the reaction vessel at a rate of 0.5 mL/min while a temperature of the reaction vessel was maintained at 0° C. After a diluted solution was added, the flow of nitrogen was lowered to 1500 mL/min, and the flow of fluorine was lowered to 300 mL/min. An appropriate amount of fluorine was introduced while the temperature of the reaction vessel was maintained at 0° C. and while the flow of nitrogen and the flow of fluorine were maintained for 30 minutes. Thereafter, introduction of fluorine was stopped. Subsequently, the reaction vessel was purged with nitrogen, and then 53 g of methanol was added to this reaction vessel. A solid was filtered out of a resulting reaction mixture, and a filtrate was concentrated and purified by distillation, so that 95 g of a perfluoro compound having a methylesterified terminal was obtained.

In a 1 L four-neck flask, 21 g of sodium boron hydride and 190 g of ethanol were placed. Into the four-neck flask, 95 g of the perfluoro compound diluted with 200 g of Novec7100 and having a methylesterified terminal was dropped at a rate of 5 g/min and then stirred at 40° C. for 16 hours. In the four-neck flask, 95 g of 3% hydrochloric acid was added so as to stop a reaction, and a target compound dissolved in Novec7100 was separated from a water layer and extracted. A crude product was obtained by concentrating and drying an extraction layer. Thereafter, the crude product was purified by column chromatography and distillation, so that 33 g of the compound 2 whose terminal group was reduced to an alcohol group was obtained. The compound 2 thus obtained was a waxy white solid, and had a density of 1.7 g/cm³ at 20° C. The compound 2 was subjected to NMR measurement, and a structure thereof was identified by the following result.

¹⁹F-NMR (solvent: none, reference: OCF₂CF₂O in the product was regarded as −89.1 ppm.)

δ=−83.0 ppm[4F], δ=−89.1 ppm[44F], δ=−123.7 ppm[4F], δ=−184.1 ppm[2F]

A result of ¹⁹F-NMR has shown that the compound 2 has c=9.2.

¹H-NMR (solvent: none, reference substance: residual protons in heavy water) 6=3.0 ppm to 3.9 ppm[6H]

### Example 3: Synthesis of HOCH₂CH(OH)CF₂OCF₂CF₂O(CF₂CF₂O),CF₂CF₂OCF₂CH(OH)C F₂CF₂CF₂CF₂CH(OH)CF₂OCF₂CF₂O(CF₂CF₂O)_{c},CF₂CF₂OCF₂CH(OH)CH₂OH (Compound 3)

In an argon atmosphere, 1,968 g of HOCH₂CF₂O(CF₂CF₂O)_{c},CF₂CH₂OH (number average molecular weight: 980) and 70 g of glycidol were stirred in a solvent (410 g of t-butyl alcohol) at 70° C. for 14 hours in the presence of 10 g of potassium t-butoxide, so that a crude product was obtained. Thereafter, the crude product thus obtained was water-washed, dehydrated, and purified by silica gel column chromatography, so that 950 g of perfluoropolyether was obtained which had one hydroxy group at one terminal thereof and had two hydroxy groups at the other terminal thereof (in which an OH group at one terminal of perfluoropolyether, which is a starting material, was substituted with a dihydroxypropoxy group). A crude product was obtained by stirring 940 g of this perfluoropolyether and 63 g of 1,7-octadiene diepoxide in a solvent (410 g of t-butyl alcohol) at 70° C. for 14 hours in the presence of 10 g of sodium t-butoxide. Thereafter, the crude product thus obtained was water-washed, dehydrated, and then purified by distillation, so that 610 g of a perfluoropolyether derivative (the following compound 3-2) was obtained.

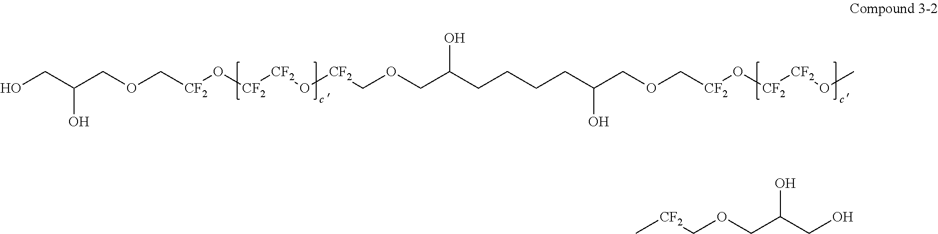

In a round-bottom recovery flask, 512 g of this perfluoropolyether derivative (compound 3-2) was placed, and 385 g of pyridine was added while the perfluoropolyether derivative was stirred. To a resulting mixture, 445 g of acetic anhydride was dropped, and the mixture was stirred at room temperature overnight. Thereafter, a reaction mixture was concentrated and dried with use of an evaporator, so that 519 g of a compound in which an OH group of the compound 3-2 was acetylated was obtained.

In a 10 L reaction vessel, 3.2 L of 1,1,2-trichlorotrifluoroethane and 2,200 g of sodium fluoride were placed. 500 g of the compound in which an OH group of the compound 3-2 was acetylated was diluted with 1,1,2-trichlorotrifluoroethane so that a post-dilution volume of 1,200 mL was obtained. A flow of nitrogen to be introduced into the reaction vessel was set at 3,400 mL/min, and a flow of fluorine to be introduced into the reaction vessel was set at 800 mL/min. The compound which was diluted with 1,1,2-trichlorotrifluoroethane and in which an OH group of the compound 3-2 was acetylated was added to the reaction vessel at a rate of 0.5 mL/min while a temperature of the reaction vessel was maintained at 0° C. After a diluted solution was added, the flow of nitrogen was lowered to 1500 mL/min, and the flow of fluorine was lowered to 300 mL/min. An appropriate amount of fluorine was introduced while the temperature of the reaction vessel was maintained at 0° C. and while the flow of nitrogen and the flow of fluorine were maintained for 30 minutes. Thereafter, introduction of fluorine was stopped. Subsequently, the reaction vessel was purged with nitrogen, and then 188 g of methanol was added to this reaction vessel. A solid was filtered out of a resulting reaction mixture, and a filtrate was concentrated and purified by distillation, so that 296 g of a perfluoro compound having a methylesterified terminal was obtained.

In a 4 L four-neck flask, a mixed solution of 49 g of sodium boron hydride and 580 g of ethanol was placed. Into the four-neck flask, 290 g of the perfluoro compound diluted with 580 g of Novec7100 and having a methylesterified terminal was dropped at a rate of 5 g/min and then stirred at 40° C. for 16 hours. In the four-neck flask, 290 g of 3% hydrochloric acid was added so as to stop a reaction, and a target compound dissolved in Novec7100 was separated from a water layer and extracted. A crude product was obtained by concentrating and drying an extraction layer. Thereafter, the crude product was purified by column chromatography and distillation, and 145 g of the compound 3 whose terminal group was reduced to an alcohol group was obtained. The compound 3 was white gelatinous, and had a density of 1.8 g/cm³ at 20° C. The compound 3 was subjected to NMR measurement, and a structure thereof was identified by the following result.

¹⁹F-NMR (solvent: none, reference substance: OCF₂CF₂O in the product was regarded as −89.1 ppm.)

δ=−77.8 ppm to −80.1 ppm[4F], δ=−82.7 ppm to −84.3 ppm[4F], δ=−89.1 ppm[80F], δ=−120.6 ppm to −128.2 ppm[8F]

A result of ¹⁹F-NMR has shown that the compound 3 has c=8.1.

¹H-NMR (solvent: none, reference substance: residual protons in heavy water) 6=2.5 ppm to 5.0 ppm[14H]

### Example 4: Synthesis of HOCH₂CH(OH)CF₂OCF₂CF₂O(CF₂CF₂O)_{c},CF₂CF₂OCF₂CH(OH)C F₂OCF₂C(CF₂CF₃)(CF₂OCF₂CH(OH)CF₂OCF₂CF₂O(CF₂CF₂O)_{c}·C F₂CF₂OCF₂CH(OH)CH₂OH)CF₂OCF₂CH(OH)CF₂OCF₂CF₂O(CF₂CF₂O)_{c},CF₂CF₂OCF₂CH(OH)CH₂OH (Compound 4)

In an argon atmosphere, 103 g of HOCH₂CF₂O(CF₂CF₂O)_{c},OCF₂CH₂OH (number average molecular weight: 980) and 7 g of glycidol are stirred in a solvent (44 g of t-butyl alcohol) at 70° C. for 14 hours in the presence of 1 g of potassium t-butoxide, so that a crude product is obtained. Thereafter, the crude product thus obtained is water-washed and then dehydrated, and further purified with use of silica gel column chromatography, so that perfluoropolyether is obtained which has one OH group at one terminal thereof and has two OH groups at the other terminal thereof (in which an OH group at one terminal of perfluoropolyether, which is a starting material, is substituted with a dihydroxypropoxy group). A crude product is obtained by stirring this perfluoropolyether and 2,2′-[[2-ethyl-2-[(2-oxiranylmethoxy)methyl]-1,3-propanediyl]bis(oxymethylene)]bis-oxirane in a solvent (t-butyl alcohol) at 70° C. for 14 hours in the presence of 1 g of sodium t-butoxide. Thereafter, the crude product thus obtained is water-washed and then dehydrated, and further purified by distillation, so that a perfluoropolyether derivative (the following compound 4-2) is obtained.

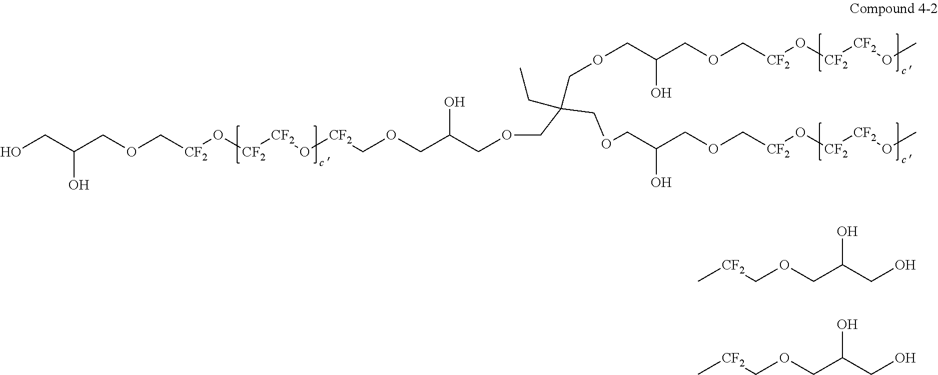

The compound 4-2 thus obtained was cetylated with use of a method identical to the method in Example 3, fluorinated by introduction of ester, and then reduced, so that the compound 4 was obtained.

### Example 5: Synthesis of HOCH₂CH(OH)CF₂OCF₂CF₂O(CF₂CF₂O)_{c},CF₂CF₂OCF₂CH(OH)C F₂OCF₂C(CF₂OCF₂CH(OH)CF₂OCF₂CF₂O(CF₂CF₂O)_{c},CF₂CF₂OC F₂CH(OH)CH₂OH)₂CF₂OCF₂CH(OH)CF₂OCF₂CF₂O(CF₂CF₂O)_{c}·C F₂CF₂OCF₂CH(OH)CH₂OH (Compound 5)

A perfluoropolyether derivative (the following compound 5-2) and a compound 5 are obtained as in the case of Example 4 except that 2,2′-[[2,2-bis[(2-oxiranylmethoxy)methyl]-1,3-propanediyl]bis(oxymethylene)]bis-oxirane is used instead of 2,2′-[[2-ethyl-2-[(2-oxiranylmethoxy)methyl]-1,3-propanediyl]bis(oxymethylene)]bis-oxirane.

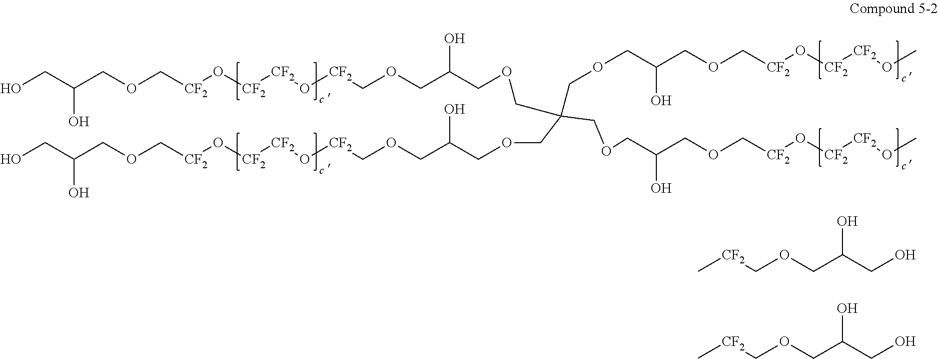

### Example 6: Synthesis of CF₃OC₆F₁₀OCF₂CH(OH)CF₂OCF₂CF₂CF₂O(CF₂CF₂CF₂O)_{d}·CF₂C F₂CF₂OCF₂CH(OH)CF₂CF₂CF₂CF₂CH(OH)CF₂OCF₂CF₂CF₂O(CF₂CF₂CF₂O)_{d}·CF₂CF₂CF₂OCF₂CH(OH)CF₂OC₆F₁₀OCF₃ (Compound 6)

A perfluoropolyether derivative (the following compound 6-2) and a compound 6 are obtained as in the case of Example 3 except that 2-[(4-methoxyphenoxy)methyl]-oxirane having the following structure is used instead of glycidol and that HOCH₂CF₂CF₂O(CF₂CF₂CF₂O)_{d}·CF₂CF₂CH₂OH is used instead of HOCH₂CF₂O(CF₂CF₂O)_{c},CF₂CH₂OH.

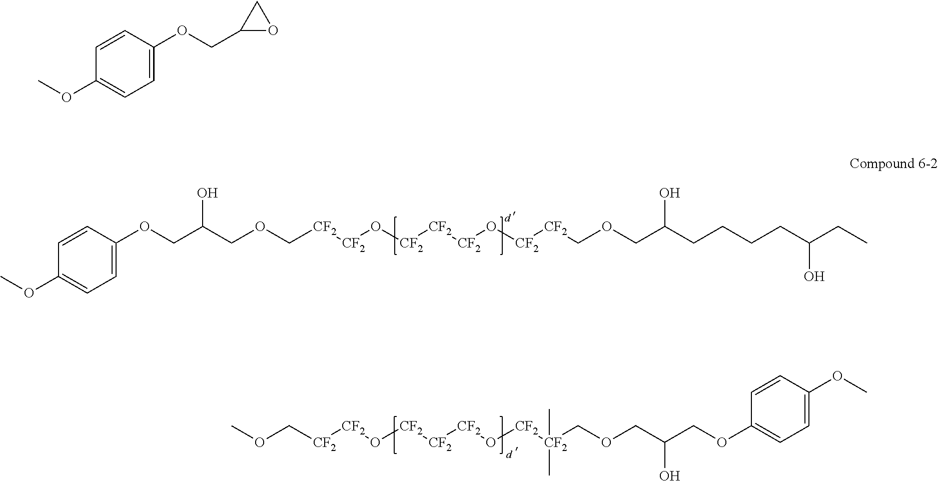

### Comparative Example 1: Synthesis of HOCH₂CH(OH)CH₂OCH₂CF₂O(CF₂CF₂O)_{c},CF₂CH₂OCH₂CH(OH) CH₂OH (Compound 1-2)

The compound 1-2 which had been obtained as a synthetic intermediate in Example 1 and in which each terminal of perfluoropolyether was modified with a dihydroxypropoxy group was used as a compound in Comparative Example 1. The compound 1-2 was a waxy white solid, and had a density of 1.7 g/cm³ at 20° C. The compound 1-2 was subjected to NMR measurement, and a structure thereof was identified by the following result.

¹⁹F-NMR (solvent: none, reference: OCF₂CF₂O in the product was regarded as−89.1 ppm.)

δ=−78.0 ppm[4F], δ=−89.1 ppm[25F]

A result of ¹⁹F-NMR has shown that the compound 1-2 has c=6.3.

¹H-NMR (solvent: none, reference substance: residual protons in heavy water)

δ=3.2 ppm to 3.9 ppm[14H], δ=4.1 ppm[4H]

### Comparative Example 2: Synthesis of (HOCH₂)₂CHCH₂CH₂OCH₂CF₂O(CF₂CF₂O)_{c},CF₂CH₂OCH₂CH₂CH(CH₂OH)₂ (Compound 2-2)

In an argon atmosphere, 211 g of HOCH₂CF₂O(CF₂CF₂O)_{c},CF₂CH₂OH (number average molecular weight: 1,590) and 58 g of 2-(2-bromoetnyl)-1,3-propanediol were stirred in a solvent (95 g of t-butyl alcohol) at 70° C. for 14 hours in the presence of 33 g of potassium t-butoxide, so that a crude product was obtained. Thereafter, the crude product thus obtained was water-washed, dehydrated, and purified by silica gel chromatography, so that 18 g of the following compound 2-2 was obtained.

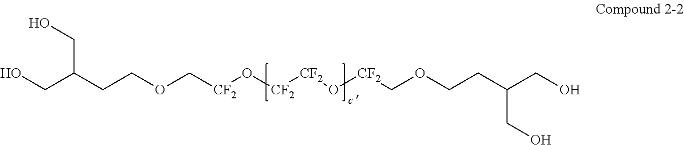

The compound 2-2 was a waxy white solid, and had a density of 1.7 g/cm³ at 20° C. The compound 2-2 was subjected to NMR measurement, and a structure thereof was identified by the following result. ¹⁹F-NMR (solvent: none, reference: OCF₂CF₂O in the product was regarded as −89.1 ppm.)

δ=−78.3 ppm[4F], δ=−89.1 ppm[36F]

A result of ¹⁹F-NMR has shown that the compound 2-2 has c=9.0.

¹H-NMR (solvent: none, reference substance: residual protons in heavy water)

δ=1.7 ppm[4H], δ=2.0 ppm[2H], δ=3.1 ppm to 3.9 ppm[20H]

### Comparative Example 3: Synthesis of HOCH₂CH(OH)CH₂OCH₂CF₂O(CF₂CF₂O)_{c}·F₂CH₂OCH₂CH(OH) CH₂CH₂CH₂CH₂CH(OH)CH₂OCH₂CF₂O(CF₂CF₂O)_{c}·CF₂CH₂OCH₂CH(OH)CH₂OH (Compound 3-2)

The perfluoropolyether derivative (compound 3-2), which is an intermediate during synthesis in Example 3, was used as a compound in Comparative Example 3.

The compound 3-2 was a waxy white solid, and had a density of 1.7 g/cm³ at 20° C. The compound 3-2 was subjected to NMR measurement, and a structure thereof was identified by the following result.

¹⁹F-NMR (solvent: none, reference substance: OCF₂CF₂O in the product was regarded as−89.1 ppm).

δ=−79.0 ppm[8F], δ=−89.1 ppm[64F]

A result of ¹⁹F-NMR has shown that the compound 3-2 has c=8.4.

¹H-NMR (solvent: none, reference substance: residual protons in heavy water)

δ=1.3 ppm[8H], δ=2.5 ppm to 5.0 ppm[30H]

### Comparative Example 4: Synthesis of HOCH₂CH(OH)CH₂OCH₂CF₂O(CF₂CF₂O)_{c}·CF₂CH₂OCH₂CH(OH) CH₂OCH₂C(CH₂CH₃)(CH₂OCH₂CH(OH)CH₂OCH₂CF₂(OCF₂CF₂)_{c}·OCF₂CH₂OCH₂CH(OH)CH₂OH)CH₂OCH₂CH(OH)CH₂OCH₂CF₂O(CF₂CF₂O)_{c}·CF₂CH₂OCH₂CH(OH)CH₂OH (Compound 4-2)

The perfluoropolyether derivative (compound 4-2), which is an intermediate in Example 4, is used as a compound in Comparative Example 4.

### Comparative Example 5: Synthesis of HOCH₂CH(OH)CH₂OCH₂CF₂(OCF₂CF₂)_{c}·OCF₂CH₂OCH₂CH(OH) CH₂OCH₂C(CH₂OCH₂CH(OH)CH₂OCH₂CF₂(OCF₂CF₂)_{c}·OCF₂CH₂OCH₂CH(OH)CH₂OH)₂CH₂OCH₂CH(OH)CH₂OCH₂CF₂(OCF₂CF₂)_{c}·OCF₂CH₂OCH₂CH(OH)CH₂OH (Compound 5-2)

The perfluoropolyether derivative (compound 5-2), which is an intermediate in Example 5, is used as a compound in Comparative Example 5.

### Comparative Example 6: Synthesis of CH₃OC₆H₄OCH₂CH(OH)CH₂OCH₂CF₂CF₂O(CF₂CF₂CF₂O)_{d}·CF₂C F₂CH₂OCH₂CH(OH)CH₂CH₂CH₂CH₂CH(OH)CH₂OCH₂CF₂CF₂O( CF₂CF₂CF₂O)_{d}·CF₂CF₂CH₂OCH₂CH(OH)CH₂OC₆H₄OCH₃ (Compound 6-2)

The perfluoropolyether derivative (compound 6-2), which is an intermediate in Example 6, is used as a compound in Comparative Example 6.

[Evaluation of Oxidative Stability by TG]

A thermogravimetric device (STA200, available from Hitachi High-Tech Science Corporation) was used to evaluate oxidative stability of the fluoropolyether compounds obtained in Examples and Comparative Examples. In a platinum container, 5 mg of each of the fluoropolyether compounds was placed, and heated to 550° C. at a temperature increase rate of 2° C./min in each of a nitrogen atmosphere and an air atmosphere. Table 1 shows <1> a temperature at a time when a weight of a lubricant was reduced by 20% in the nitrogen atmosphere, <2> a temperature at a time when the weight of the lubricant was reduced by 20% in the air atmosphere, and a difference between the temperature <1> and the temperature <2>.

TABLE 1

| | | <1> 20% | | |
|---|---|---|---|---|
| | | weight loss | <2> 20% | |
| | | temperature | weight loss | |
| | | (° C.) in | temperature | |
| | | nitrogen | (° C.) in | <1>-<2> |
| | | atmosphere | air atmosphere | (° C.) |
| Example 1 | Compound | 188 | 188 | 0 |
| | 1 | | | |
| Example 2 | Compound | 206 | 206 | 0 |
| | 2 | | | |
| Example 3 | Compound | 289 | 289 | 0 |
| | 3 | | | |
| Comparative | Compound | 216 | 206 | 10 |
| Example 1 | 1-2 | | | |
| Comparative | Compound | 236 | 213 | 23 |
| Example 2 | 2-2 | | | |
| Comparative | Compound | 302 | 236 | 66 |
| Example 3 | 3-2 | | | |

It has been found from Table 1 that in the fluoropolyether compounds of Examples 1 to 3, there is no difference between a 20% weight loss temperature in nitrogen and a 20% weight loss temperature in an oxygen-containing atmosphere. In contrast, in the fluoropolyether compounds of Comparative Examples 1 to 3, the 20% weight loss temperature was further lowered in an oxygen-containing air atmosphere than in nitrogen. Furthermore, in a case where heating was stopped when a weight of a fluoropolyether compound was reduced by 20% in an air atmosphere, and a compound remaining in the platinum container was analyzed. As a result, a compound having a structure in which the compound was decomposed at a hydrocarbon ether site was observed in the fluoropolyether compounds of Comparative Examples. However, such a compound was not observed in Examples. These results show that the fluoropolyether compounds of Comparative Examples undergo oxidative decomposition by oxygen contained in air, whereas the fluoropolyether compounds of Examples do not undergo oxidative decomposition by oxygen. Thus, it can be said that in a case where any of the fluoropolyether compounds of Examples is used as the lubricant, the lubricant is less likely to be decomposed even in an oxygen-containing high-temperature atmosphere. Note that the present test evaluated oxidative stability of the fluoropolyether compound itself. Stability in the case of application of the fluoropolyether compound to a magnetic disk will be described later.

[Evaluation of Stability of Lubricant Layer Formed on Magnetic Disk]

The fluoropolyether compounds obtained in Example 1 and Comparative Example 1 were each used as the lubricant to evaluate stability of a lubricant layer formed on a magnetic disk. Specifically, the fluoropolyether compounds obtained in Example 1 and Comparative Example 1 were each diluted by being dissolved in VETREL XF (available from Chemours-Mitsui Fluoroproducts Co., Ltd.). The lubricant thus diluted was applied to a magnetic disk by a dip method so that a lubricant layer would have a thickness of 0.7 nm. FT-IR (VERTEX70, available from Bruker) was used to measure the thickness of the lubricant layer. The magnetic disk to which the lubricant was applied was irradiated with ultraviolet light (with a mixed wavelength of 254 nm and 185 nm) in a nitrogen atmosphere for an arbitrary time (for 40 seconds in the case of the lubricant in Example 1 and for 20 seconds in the case of the lubricant in Comparative Example 1). Thereafter, the magnetic disk was immersed in a mixed solution of VERTREL-XF and methanol (VERTREL-XF: methanol=66:33 v/v) for 3 minutes, and molecules of the lubricant that were not bonded to the magnetic disk was washed out (rinsed), so that a magnetic disk provided with a lubricant film was obtained. Note that a time of ultraviolet irradiation was set so that a case where the fluoropolyether compound of Example 1 was used and a case where the fluoropolyether compound of Comparative Example 1 was used would be identical in thickness of the lubricant after rinsing. The magnetic disk was heated in an oven (Clean Oven DE42, available from Yamato Scientific Co., Ltd.) at 150° C. in an air atmosphere. The thickness of the lubricant film for each heating time was measured so that a remaining thickness ratio was calculated. Table 2 shows the heating time and the remaining thickness ratio of each lubricant film.

TABLE 2

Heating time (min)

| | | 0 | 20 | 40 | 60 |
|---|---|---|---|---|---|
| Film remaining | Example 1 | 100 | 86 | 85 | 81 |
| thickness ratio | Comparative | 100 | 60 | 51 | 44 |
| (%) | Example 1 | | | | |

It has been found from Table 2 that a lubricant in Example 1 had a higher remaining thickness ratio than a lubricant in Comparative Example 1 even after 60 minutes of heating. Note that in the evaluation of oxidative stability by TG, the 20% weight loss temperature in the air atmosphere was higher in Comparative Example 1 than in Example 1. This is because the 20% weight loss temperature by TG is influenced not only by oxidative stability of the lubricant but also a boiling point of the lubricant. However, in a case where a lubricant is applied to a magnetic disk and ultraviolet treatment is carried out, molecules of the lubricant on the disk form a film in a state in which the molecules of the lubricant are bonded to a surface of the disk. It has therefore been shown that a lubricant layer in Example 1 exhibits high oxidative stability and high heat resistance on a magnetic disk.

[Evaluation of Stability of Lubricant Layer with Respect to Ultraviolet Light]

The fluoropolyether compounds obtained in Example 1 and Comparative Example 1 were each used as the lubricant to evaluate stability of a lubricant layer, formed on a magnetic disk, with respect to ultraviolet light. Specifically, the fluoropolyether compounds obtained in Example 1 and Comparative Example 1 were each diluted by being dissolved in VETREL XF (available from Chemours-Mitsui Fluoroproducts Co., Ltd.). The lubricant thus diluted was applied to a magnetic disk by a dip method so that ta lubricant layer would have a thickness of 8 Å. FT-IR (VERTEX70, available from Bruker) was used to measure the thickness of the lubricant layer. The disk to which the lubricant was applied was irradiated with ultraviolet light (with a mixed wavelength of 254 nm and 185 nm) in a nitrogen atmosphere for 20 seconds. Thereafter, the thickness on the disk was measured, and a ratio of the thickness made smaller after ultraviolet irradiation relative to the thickness before ultraviolet irradiation was calculated. A result of this is shown in Table 3.

TABLE 3

| | Ratio (%) of thickness reduced during period |
|---|---|
| Lubricant | before and after ultraviolet irradiation |
| Example 1 | 1.0 |
| Comparative | 5.4 |
| Example 1 | |

It has been found from Table 3 that the lubricant in Example 1 showed a smaller reduction in thickness during a period before and after ultraviolet irradiation than the lubricant in Comparative Example 1. That is, it has been shown that the lubricant in Example 1 has excellent ultraviolet resistance.

### INDUSTRIAL APPLICABILITY

A fluoropolyether compound in accordance with an aspect of the present invention can be suitably used as a lubricant for magnetic disks.

### REFERENCE SIGNS LIST

1: Magnetic disk
2: Lubricant layer
3: Protective film layer (protective layer)
4: Recording layer
5: Lower layer
6: Soft magnetic lower layer
7: Adhesive layer
8: Non-magnetic substrate

1. A fluoropolyether compound represented by the following Formula (1): 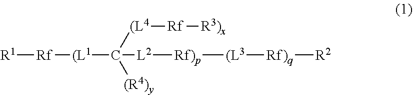
where: Rf are each independently a perfluoropolyether group;
R¹ is a hydrocarbon group having two or more OH groups, or a hydrocarbon group having at least one cyclic hydrocarbon group;
R² and R³ are each independently a hydrocarbon group having at least one OH group, or a hydrocarbon group having at least one cyclic hydrocarbon group;
L¹, L², L³, and L⁴ are each independently a hydrocarbon group, and the hydrocarbon group may contain an OH group and/or an ether bond;
R⁴ is a hydrogen atom or a hydrocarbon group, and the hydrocarbon group may contain an OH group and/or an ether bond;
p is an integer of 0 to 1, q is a real number of 0 to 10, and when p=1, (i) x=1 and y=1 or (ii) x=2 and y=0;
in a molecule, a hydrogen atom bonded to a carbon atom contained in a hydrocarbon group may be substituted with a fluorine atom; and
at least any one of R¹, R², and R³ may contain an ether bond obtained by substituting at least one carbon atom with an oxygen atom, and at least one hydrogen atom bonded to a carbon atom adjacent to the oxygen atom of the ether bond is substituted with a fluorine atom.

2. The fluoropolyether compound according to claim 1, wherein
R¹ is a hydrocarbon group having 2 to 10 carbon atoms and having two or more OH groups, or a hydrocarbon group having 3 to 25 carbon atoms and having at least one cyclic hydrocarbon group,
R² and R³ are each independently a hydrocarbon group having 1 to 10 carbon atoms and having at least one OH group, or a hydrocarbon group having 3 to 25 carbon atoms and having at least one cyclic hydrocarbon group, and
at least any one of R¹, R², and R³ may contain an ether bond obtained by substituting at least one carbon atom with an oxygen atom.

3. The fluoropolyether compound according to claim 1, wherein
L¹, L², L³, and L⁴ are hydrocarbon groups having 1 to 25 carbon atoms, and
the hydrocarbon groups each may independently have at least one OH group and/or contain an ether bond.

4. The fluoropolyether compound according to claim 1, wherein in a case where at least any one of R¹, R², and R³ contains at least one ether bond, all hydrogen atoms bonded to a carbon atom adjacent to an oxygen atom of the at least one ether bond are substituted with fluorine atoms.

5. The fluoropolyether compound according to claim 1, wherein in a case where at least any one of R¹, R², and R³ contains at least one ether bond, all hydrogen atoms bonded to a carbon atom adjacent to an oxygen atom of all the at least one ether bond are substituted with fluorine atoms.

6. The fluoropolyether compound according to claim 1, wherein in a case where at least any one of L¹, L², L³, L⁴, and R⁴ contains at least one ether bond, all hydrogen atoms bonded to a carbon atom adjacent to an oxygen atom of all the at least one ether bond are substituted with fluorine atoms.

7. The fluoropolyether compound according to claim 1, wherein all hydrogen atoms bonded to carbon atoms other than carbon atoms bonded to the OH groups of R¹, R², R³, R⁴, L¹, L², L³, and L⁴ are substituted with fluorine atoms.

8. A lubricant comprising a fluoropolyether compound according to claim 1.

9. A magnetic disk comprising:
a recording layer;
a protective layer disposed on the recording layer; and
a lubricant layer disposed on the protective layer,
the lubricant layer containing a lubricant according to claim 8.

10. A method for producing a fluoropolyether compound, comprising:
an esterification step of introducing ester into a compound;
a fluorination step of fluorinating the ester obtained in the esterification step; and
a reduction step of reducing the fluorinated ester obtained in the fluorination step,
the compound being represented by the following Formula (2): 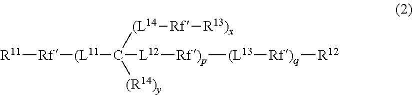
where: Rf′ are each independently a perfluoropolyether group;
R¹¹, R¹², and R¹³ are each independently a hydrocarbon group having at least one OH group;
L¹¹, L¹², L¹³, and L¹⁴ are each independently a hydrocarbon group, and the hydrocarbon group may contain an OH group and/or an ether bond;
R¹⁴ is a hydrocarbon group or a hydrogen atom, and the hydrocarbon group may have an OH group and/or contain an ether bond;
at least any one of R¹¹, R¹², and R¹³ contains an ether bond obtained by substituting at least one carbon atom with an oxygen atom; and
p is an integer of 0 to 1, q is a real number of 0 to 10, and when p=1, (i) x=1 and y=1 or (ii) x=2 and y=0.
